(19) United States
(12) Patent Application Publication
(10) Pub. No.: US 2026/0221156 A1
(43) Pub. Date: Jul. 30, 2026

(54) MAGNETIC RECORDING MEDIUM AND CARTRIDGE

(71) Applicant: Sony Group Corporation, Tokyo (JP)

(72) Inventors: Minoru YAMAGA, Tokyo (JP); Futoshi SASAKI, Tokyo (JP)

(21) Appl. No.: 19/143,192

(22) PCT Filed: Jan. 30, 2024
(86) PCT No.: PCT/JP2024/002790

§ 371 Date: Jun. 25, 2025

(30) Foreign Application Priority Data
Jan. 31, 2023 (JP) 2023-013682

(51) Int. Cl. G11B 5/78; G11B 5/592; G11B 5/706; G11B 5/714; G11B 5/735

(52) U.S. Cl. CPC G11B 5/78; G11B 5/5928; G11B 5/70678; G11B 5/714; G11B 5/7358

(57) ABSTRACT

Provided is a magnetic recording medium capable of suppressing adhesion of a configuration material of a magnetic layer to a head during traveling.

A magnetic recording medium is a magnetic recording medium in a tape shape, and includes a base and a magnetic layer. The magnetic recording medium contains a lubricant. The magnetic layer contains magnetic particles, a binder, and carbon. In a case where an average electron count rate of a surface of a standard sample measured by atmospheric photoelectron yield spectroscopy is A₀, an average electron count rate of a surface of the magnetic layer measured by the atmospheric photoelectron yield spectroscopy before cleaning of the magnetic recording medium is A₁, and an average electron count rate of the surface of the magnetic layer measured by the atmospheric photoelectron yield spectroscopy after cleaning of the magnetic recording medium is A₂, ((A₂/A₀)−(A₁/A₀))/(A₂/A₀) satisfies 0.20≤((A₂/A₀)−(A₁/A₀))/(A₂/A₀)≤0.49.

### TECHNICAL FIELD

The present disclosure relates to a magnetic recording medium in a tape shape and a cartridge including the magnetic recording medium.

### BACKGROUND ART

With an increase in the total capacity of a cartridge, it has been desired to improve the transfer speed in addition to improving the surface property of a magnetic recording medium in a tape shape. Therefore, it is required to stably slide a head at a high speed with respect to the surface of a magnetic layer. In order to enable such high-speed sliding, it is necessary to optimize an amount of lubricant on the surface of the magnetic layer. For example, Patent Document 1 discloses that the addition amount of the lubricant is 0.5 to 5.0% by mass in terms of a mass ratio of the entire magnetic layer.

### CITATION LIST

### Patent Document

Patent Document 1: Japanese Patent Application Laid-Open No. 2017-16732

### SUMMARY OF THE INVENTION

### Problems to be Solved by the Invention

Conventionally, the presence amount of a lubricant has been generally found by the addition amount of the lubricant in a manufacturing process, the amount of the lubricant extracted from a magnetic recording medium by a solvent, or the like. However, in these methods, it is difficult to extract information on the amount of lubricant actually present at a contact portion between the head and the surface of the magnetic layer. Therefore, in the conventional magnetic recording medium, the amount of lubricant present at the contact portion between the head and the surface of the magnetic layer may not be appropriate. In a case where the amount of lubricant is not appropriate, dynamic friction between the surface of the magnetic layer and the head may increase during traveling.

An object of the present disclosure is to provide a magnetic recording medium capable of suppressing an increase in dynamic friction between a surface of a magnetic layer and a head during traveling, and a cartridge including the magnetic recording medium.

### Solutions to Problems

In order to solve the above problem, a magnetic recording medium of the present disclosure is a magnetic recording medium in a tape shape, including:
a base; and
a magnetic layer, in which
the magnetic recording medium contains a lubricant,
the magnetic layer contains magnetic particles, a binder, and carbon, and
in a case where an average electron count rate of a surface of a standard sample measured by atmospheric photoelectron yield spectroscopy is A₀, an average electron count rate of a surface of the magnetic layer measured by the atmospheric photoelectron yield spectroscopy before cleaning of the magnetic recording medium is A₁, and an average electron count rate of the surface of the magnetic layer measured by the atmospheric photoelectron yield spectroscopy after cleaning of the magnetic recording medium is A₂, ((A₂/A₀)−(A₁/A₀))/(A₂/A₀) satisfies 0.20≤((A₂/A₀)−(A₁/A₀))/(A₂/A₀)≤0.49.

A cartridge according to the present disclosure includes the magnetic recording medium according to the present disclosure.

### BRIEF DESCRIPTION OF DRAWINGS

FIG. 1 is an exploded perspective view illustrating an example of a configuration of a cartridge according to one embodiment of the present disclosure.

FIG. 2 is a block diagram illustrating an example of a configuration of a cartridge memory.

FIG. 3A is a cross-sectional view illustrating an example of a configuration of a magnetic tape. FIG. 3B is an enlarged cross-sectional view illustrating an example of a configuration near a surface of the magnetic tape.

FIG. 4 is a schematic diagram illustrating an example of a layout of data bands and servo bands.

FIG. 5 is an enlarged view illustrating an example of a configuration of a data band.

FIG. 6 is an enlarged view illustrating an example of a configuration of a servo band.

FIG. 7 is a perspective view illustrating an example of a shape of a particle.

FIG. 8 is a diagram illustrating a first example of a cross-sectional TEM image of a magnetic layer.

FIG. 9 is a diagram illustrating a second example of the cross-sectional TEM image of the magnetic layer.

FIG. 10A is a schematic diagram of a measurement device for measuring a friction coefficient between a surface of a magnetic layer and a head. FIG. 10B is a plan view of the measurement device as viewed from a direction of an arrow 70A in FIG. 10A.

FIG. 11 is an exploded perspective view illustrating an example of a configuration of a cartridge according to a modification of one embodiment of the present disclosure.

FIG. 12 is a graph illustrating a relationship between A₂−A₁ and ((A₂/A₀)−(A₁/A₀))/(A₂/A₀).

### MODE FOR CARRYING OUT THE INVENTION

Embodiments of the present disclosure are described in the following order.
1 Configuration of cartridge
2 Configuration of cartridge memory
3 Configuration of magnetic tape
4 Manufacturing method of magnetic tape
5 Operations and effects
6 Modifications

In the present specification, in a case where a measurement method and an evaluation method are described without a particular description of a measurement environment, the measurement and the evaluation are performed under an environment of 25° C.±2° C. and 50% RH±5% RH.

### [1 Configuration of Cartridge]

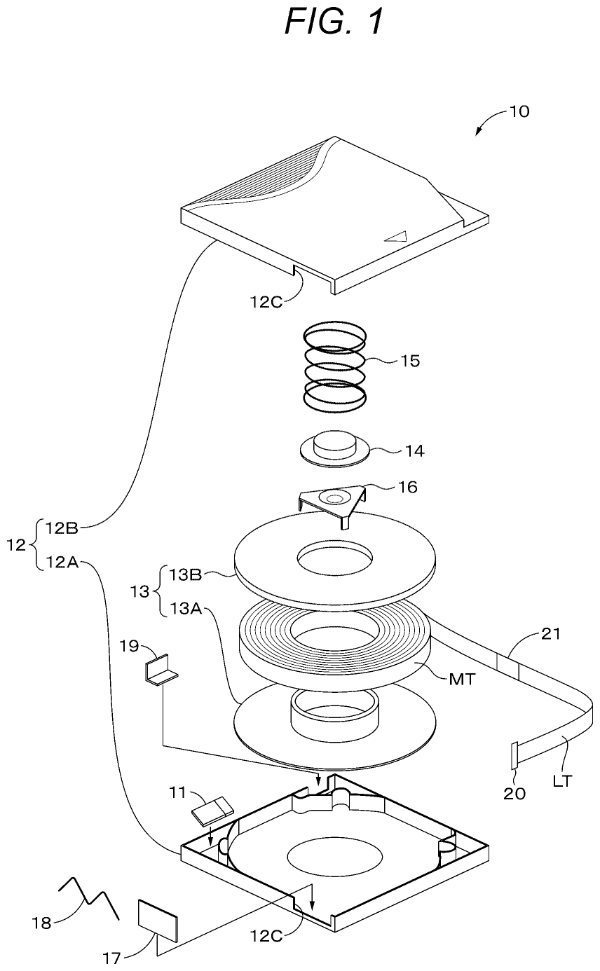

FIG. 1 is an exploded perspective view illustrating an example of a configuration of a cartridge 10. The cartridge 10 is a one-reel type cartridge, and includes one reel 13 around which a magnetic recording medium (hereinafter, referred to as a “magnetic tape”) MT in a tape shape is wound inside a cartridge case 12 including a lower shell 12A and an upper shell 12B, a reel lock 14 and a reel spring 15 for locking rotation of the reel 13, a spider 16 for releasing a locked state of the reel 13, a slide door 17 for opening and closing a tape drawing port 12C provided in the cartridge case 12 across the lower shell 12A and the upper shell 12B, a door spring 18 for biasing the slide door 17 to a closed position of the tape drawing port 12C, a write protect 19 for preventing erroneous erasure, and a cartridge memory 11. The reel 13 for winding the magnetic tape MT has a substantially disk shape having an opening in a central portion, and includes a reel hub 13A and a flange 13B including a hard material such as plastic. A reader tape LT is connected to an end portion on an outer peripheral side of the magnetic tape MT. A leader pin 20 is provided at a tip of the reader tape LT.

The cartridge 10 may be a magnetic tape cartridge according to a linear tape-open (LTO) standard, or may be a magnetic tape cartridge according to a standard different from the LTO standard.

The cartridge memory 11 is provided near one corner of the cartridge 10. In a state where the cartridge 10 is loaded into a recording/reproducing device, the cartridge memory 11 faces a reader-writer of the recording/reproducing device. The cartridge memory 11 communicates with the recording/reproducing device, specifically, with the reader-writer by a wireless communication standard according to the LTO standard.

### [2 Configuration of Cartridge Memory]

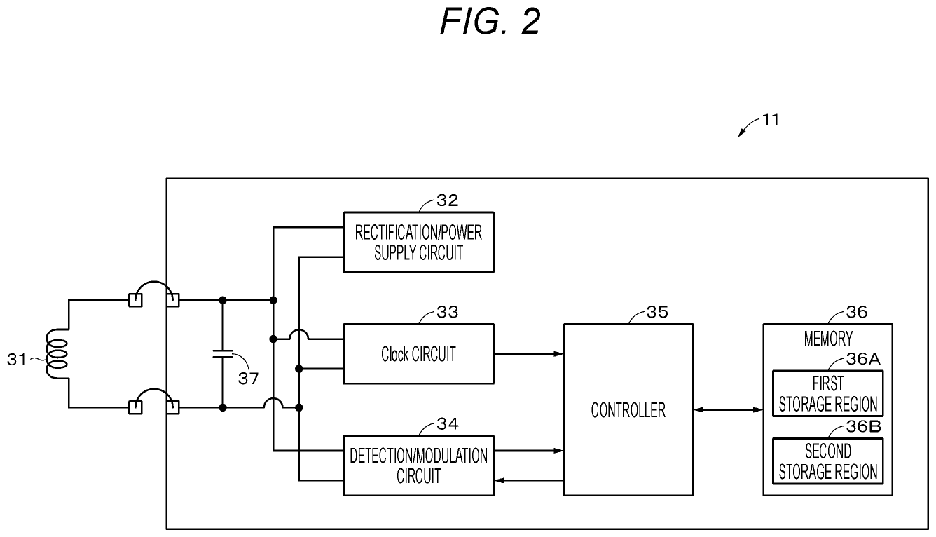

FIG. 2 is a block diagram illustrating an example of a configuration of the cartridge memory 11. The cartridge memory 11 includes an antenna coil (communication section) 31 that communicates with the reader-writer according to a prescribed communication standard, a rectification/power supply circuit 32 that generates electric power from an electric wave received from the antenna coil 31 by use of an induced electromotive force, and rectifies the electric power to generate a power supply, a clock circuit 33 that generates a clock from the electric wave received from the antenna coil 31 by similarly using the induced electromotive force, a detection/modulation circuit 34 that performs detection of the electric wave received from the antenna coil 31 and modulation of a signal to be transmitted from the antenna coil 31, a controller (control section) 35 including a logical circuit or the like for discriminating commands and data from a digital signal extracted from the detection/modulation circuit 34 and for processing the commands and data, and a memory (storage section) 36 that stores information. Furthermore, the cartridge memory 11 includes a capacitor 37 connected in parallel to the antenna coil 31, and the antenna coil 31 and the capacitor 37 constitute a resonance circuit.

The memory 36 stores information concerning the cartridge 10 and the like. The memory 36 is a non-volatile memory (NVM). The memory 36 preferably has a storage capacity of about 32 KB or more.

The memory 36 may include a first storage region 36A and a second storage region 36B. The first storage region 36A corresponds to, for example, a storage region of a cartridge memory of a magnetic tape standard before a specified generation (for example, LTO standards before LTO8), and is a region for storing information according to the magnetic tape standard before the specified generation. The information according to the magnetic tape standard before the specified generation is, for example, manufacturing information (for example, specific number of the cartridge 10 or the like), use history (for example, the number of times of tape draw-out (Thread Count)), and the like.

The second storage region 36B corresponds to an extension storage region in regard of the storage region of the cartridge memory of the magnetic tape standard before the specified generation (for example, LTO standards before LTO8). The second storage region 36B is a region for storing additional information. Here, the additional information means, for example, information concerning the cartridge 10 that is not prescribed in the magnetic tape standard before the specified generation (for example, LTO standards before LTO8). The additional information includes, for example, at least one type of information selected from the group consisting of tension adjustment information, management ledger data, index information, thumbnail information, and the like, but is not limited to these data. The tension adjustment information is information for adjusting the tension applied to the magnetic tape MT in the longitudinal direction. The tension adjustment information includes, for example, at least one type of information selected from the group consisting of information obtained by intermittently measuring a width between servo bands in the longitudinal direction of the magnetic tape MT, drive tension information, drive temperature and humidity information, and the like. These pieces of information may be managed in cooperation with information associated with a usage status of the cartridge 10 or the like. The tension adjustment information is preferably acquired at the time of data recording on the magnetic tape MT or before data recording. The drive tension information means information on the tension applied to the magnetic tape MT in the longitudinal direction.

The management ledger data is data including at least one type selected from the group consisting of the capacity, creation date, editing date, storage location, and the like of a data file recorded on the magnetic tape MT. The index information is metadata or the like for searching the content of the data file. The thumbnail information is a thumbnail of a moving image or a still image stored on the magnetic tape MT.

The memory 36 may include a plurality of banks. In this case, some of the plurality of banks may constitute the first storage region 36A, and the remaining banks may constitute the second storage region 36B.

The antenna coil 31 induces an induced voltage by electromagnetic induction. The controller 35 communicates with the recording/reproducing device according to a prescribed communication standard through the antenna coil 31. Specifically, for example, mutual authentication, transmission and reception of commands, and exchange of data are performed.

The controller 35 stores information received from the recording/reproducing device through the antenna coil 31 in the memory 36. For example, the tension adjustment information received from the recording/reproducing device through the antenna coil 31 is stored in the second storage region 36B of the memory 36. In response to a request from the recording/reproducing device, the controller 35 reads information from the memory 36, and transmits the information to the recording/reproducing device through the antenna coil 31. For example, in response to the request from the recording/reproducing device, the tension adjustment information is read from the second storage region 36B of the memory 36 and transmitted to the recording/reproducing device through the antenna coil 31.

### [3 Configuration of Magnetic Tape]

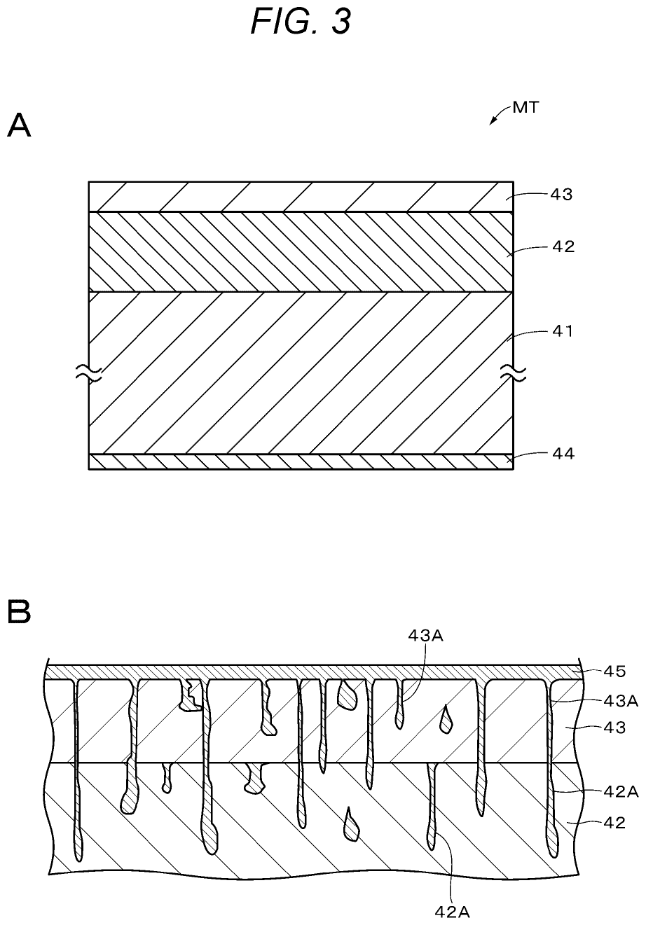

FIG. 3A is a cross-sectional view illustrating an example of a configuration of the magnetic tape MT. The magnetic tape MT is provided with an elongated base 41, an underlayer 42 provided on one principal surface (first principal surface) of the base 41, a magnetic layer 43 provided on the underlayer 42, and a back layer 44 provided on the other principal surface (second principal surface) of the base 41. Note that the underlayer 42 and the back layer 44 are provided as necessary and they are not necessarily provided. The magnetic tape MT may be a perpendicular recording type magnetic recording medium or may be a longitudinal recording type magnetic recording medium. The magnetic tape MT preferably contains a lubricant from the viewpoint of improving traveling performance. The lubricant may be contained in at least one of the underlayer 42 or the magnetic layer 43.

FIG. 3B is an enlarged cross-sectional view illustrating an example of a configuration near a surface of the magnetic tape MT. The magnetic tape MT may further include a lubricant layer 45 provided on a surface (hereinafter, the magnetic surface is appropriately referred to as a “magnetic surface”) of the magnetic layer 43.

The magnetic tape MT may conform to the LTO standard, or may conform to a standard different from the LTO standard. The width of the magnetic tape MT may be ½ inches, or may be wider than ½ inches. In a case where the magnetic tape MT conforms to the LTO standard, the width of the magnetic tape MT is ½ inches. The magnetic tape MT may have a configuration in which the width of the magnetic tape MT can be kept constant or substantially constant by adjusting tension, applied in the longitudinal direction of the magnetic tape MT during traveling, by the recording/reproducing device (drive).

The magnetic tape MT has an elongated shape and runs in the longitudinal direction during recording and reproducing. The magnetic tape MT is preferably used in a recording/reproducing device provided with a ring head as a recording head. The magnetic tape MT is preferably used in a recording/reproducing device configured to be able to record data with a data track width of 1200 nm or less or 1000 nm or less.

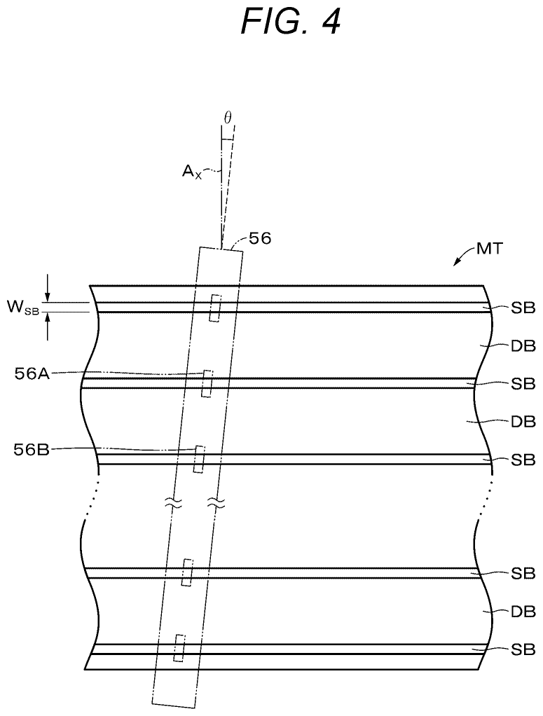

The magnetic tape MT is preferably reproduced by a reproducing head using a TMR element. The signal reproduced by the reproducing head using TMR may be data recorded in a data band DB (see FIG. 4) or a servo pattern (servo signal) recorded in a servo band SB (see FIG. 4).

### (Base)

The base 41 is a nonmagnetic supporting body which supports the underlayer 42 and the magnetic layer 43. The base 41 has an elongated film shape. An upper limit value of an average thickness of the base 41 is preferably 4.40 μm or less, more preferably 4.20 μm or less, and still more preferably 4.00 μm or less, 3.80 μm or less, or 3.40 μm or less. When the upper limit value of the average thickness of the base 41 is 4.40 μm or less, a recording capacity which can be recorded in one data cartridge can be increased as compared with that in a general magnetic tape. A lower limit value of the average thickness of the base 41 is preferably 3.00 μm or more, and more preferably 3.20 μm or more. When the lower limit value of the average thickness of the base 41 is 3.00 μm or more, reduction in strength of the base 41 can be suppressed.

The average thickness of the base 41 is obtained as follows. First, the magnetic tape MT accommodated in the cartridge 10 is unwound, and the magnetic tape MT is cut out to a length of 250 mm at a position of 30 m to 40 m in a longitudinal direction from one end on an outer peripheral side of the magnetic tape MT, thereby preparing a sample. In the present specification, the “longitudinal direction” in the case of the “longitudinal direction from one end on outer peripheral side of magnetic tape MT” means a direction from one end on the outer peripheral side toward the other end on an inner peripheral side of the magnetic tape MT.

Subsequently, layers other than the base 41 of the sample (that is, the underlayer 42, the magnetic layer 43, and the back layer 44) are removed by a solvent such as methyl ethyl ketone (MEK) or dilute hydrochloric acid. Next, a thickness of the sample (base 41) is measured in five positions using a laser holo gauge (LGH-110C) manufactured by Mitutoyo as a measurement device, and simply averages (arithmetically averages) the measured values to calculate the average thickness of the base 41. Note that the five measurement positions described above are randomly selected from the sample so as to be different positions in the longitudinal direction of the magnetic tape MT.

The base 41 contains, for example, a polyester-based resin as a main component. The polyester-based resin contains, for example, at least one type selected from the group consisting of polyethylene terephthalate (PET), polyethylene naphthalate (PEN), polybutylene terephthalate (PBT), polybutylene naphthalate (PBN), polycyclohexylenedimethylene terephthalate (PCT), polyethylene-p-oxybenzoate (PEB), and polyethylene bisphenoxycarboxylate. In a case where the base 41 contains two or more types of polyester-based resins, the two or more types of polyester-based resins may be mixed, copolymerized, or stacked. At least one of a terminal and a side chain of the polyester-based resin may be modified. In addition to the polyester-based resin, the base 41 may contain a resin described later other than the polyester-based resin.

In the present specification, the “main component” means a component having the highest content ratio among the components constituting the base 41. For example, in a case where the main component of the base 41 is a polyester-based resin, a content ratio of the polyester-based resin in the base 41 may be, for example, 50% by mass or more, 60% by mass or more, 70% by mass or more, 80% by mass or more, 90% by mass or more, 95% by mass or more, or 98% by mass or more with respect to the mass of the base 41, or the base 41 may contain only polyester-based resin.

The inclusion of the polyester-based resin in the base 41 is confirmed, for example, as follows. First, similarly to the method of measuring the average thickness of the base 41, the magnetic tape MT is prepared, and cut into a length of 250 mm to prepare a sample, and then layers other than the base 41 of the sample are removed. Next, an IR spectrum of the sample (base 41) is acquired by infrared absorption spectroscopy (IR). On the basis of this IR spectrum, it can be confirmed that the polyester-based resin is contained in the base 41.

The base 41 preferably contains the polyester-based resin. When the base 41 contains the polyester-based resin, the Young's modulus of the base 41 in the longitudinal direction can be reduced to preferably 2.5 GPa or more and 7.8 GPa or less, and more preferably 3.0 GPa or more and 7.0 GPa or less. Therefore, the width of the magnetic tape MT can be kept constant or substantially constant by adjusting the tension in the longitudinal direction of the magnetic tape MT during traveling by the recording/reproducing device. A method of measuring the Young's modulus of the base 41 in the longitudinal direction will be described later.

The base 41 may contain a resin other than the polyester-based resin. In this case, the resin other than the polyester-based resin may be the main component of a configuration material of the base 41. For example, in a case where the resin other than the polyester-based resin is the main component of the base 41, a content ratio of the resin other than the polyester-based resin in the base 41 may be, for example, 50% by mass or more, 60% by mass or more, 70% by mass or more, 80% by mass or more, 90% by mass or more, 95% by mass or more, or 98% by mass or more with respect to the mass of the base 41, or the base 41 may contain only the resin other than the polyester-based resin. The resin other than the polyester-based resin contains, for example, at least one selected from the group consisting of a polyolefin-based resin, a cellulose derivative, a vinyl-based resin, and other polymer resins. In a case where the base 41 contains two or more types of these resins, the two or more types of materials may be mixed, copolymerized, or stacked.

The polyolefin-based resin contains, for example, at least one selected from the group consisting of polyethylene (PE) and polypropylene (PP). The cellulose derivative contains, for example, at least one selected from the group consisting of cellulose diacetate, cellulose triacetate, cellulose acetate butyrate (CAB), or cellulose acetate propionate (CAP). The vinyl-based resin contains, for example, at least one selected from the group consisting of polyvinyl chloride (PVC) or polyvinylidene chloride (PVDC).

Other polymer resins include, for example, at least one type selected from the group consisting of polyether ether ketone (PEEK), polyamide, (PA, nylon), aromatic polyamide (aromatic PA, aramid), polyimide (PI), aromatic polyimide (aromatic PI), polyamide imide (PAI), aromatic polyamide imide (aromatic PAI), polybenzoxazole (PBO, for example, ZYLON (registered trademark)), polyether, polyether ketone (PEK), polyether ester, polyether sulfone (PES), polyether imide (PEI), polysulfone (PSF), polyphenylene sulfide (PPS), polycarbonate (PC), polyarylate (PAR), and polyurethane (PU). Specifically, the base 41 contains, for example, polyether ether ketone (PEEK), polyamide, (PA, nylon), aromatic polyamide (aromatic PA, aramid), polyimide (PI), aromatic polyimide (aromatic PI), polyamide imide (PAI), aromatic polyamide imide (aromatic PAI), polybenzoxazole (PBO, for example, ZYLON (registered trademark)), polyether, polyether ketone (PEK), polyether ester, polyether sulfone (PES), polyether imide (PEI), polysulfone (PSF), polyphenylene sulfide (PPS), polycarbonate (PC), polyarylate (PAR), or polyurethane (PU) as a main component.

The base 41 may be biaxially stretched in the longitudinal direction and the width direction. The polymer resin contained in the base 41 is preferably oriented in an oblique direction with respect to the width direction of the base 41.

(Magnetic layer)

The magnetic layer 43 is configured to be able to record a signal by a magnetization pattern. The magnetic layer 43 may be a perpendicular recording type recording layer or may be a longitudinal recording type recording layer. The magnetic layer 43 contains, for example, magnetic particles, a binder, carbon particles, and lubricant. The magnetic layer 43 may further contain at least one type of additive selected from the group consisting of abrasive particles, an antistatic agent, a curing agent, a rust-preventive agent, nonmagnetic reinforcing particles, and the like, as necessary. The magnetic layer 43 may include a plurality of protrusions on a surface (magnetic surface) on a magnetic layer 43 side. The plurality of protrusions includes, for example, carbon particles and abrasive particles protruding from the magnetic surface.

As illustrated in FIG. 3B, the magnetic layer 43 may include a plurality of holes 43A on the surface. A lubricant may be stored in each of the holes 43A. In this case, a supply property of the lubricant to the magnetic surface can be improved. From a viewpoint of improving the supply property of the lubricant to the magnetic surface, it is preferable that the holes 43A are provided to extend in a direction perpendicular to the magnetic surface.

The magnetic layer 43 may include a plurality of the servo bands SB and a plurality of the data bands DB in advance as illustrated in FIG. 4. The plurality of servo bands SB is provided at equal intervals in a width direction of the magnetic tape MT. The data band DB is provided between the adjacent servo bands SB. The servo band SB is for guiding a head unit (magnetic head) 56 (specifically, servo read heads 56A and 56B) at the time of recording or reproducing data. In the servo band SB, a servo pattern (servo signal) for performing tracking control on the head unit 56 is written in advance. User data is recorded in the data band DB.

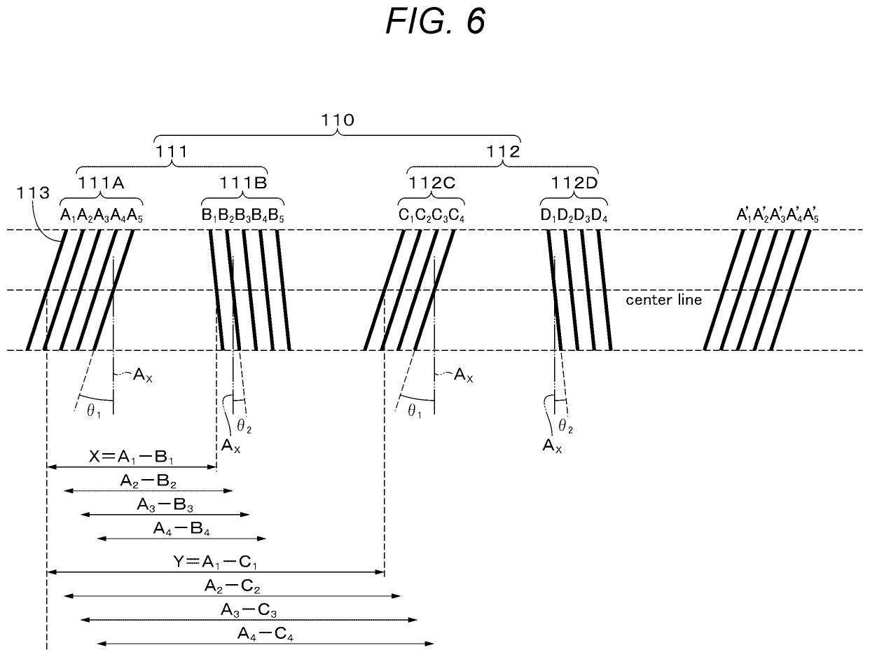

In order to read an asymmetric servo stripe 113 (see FIG. 6) to be described later, as illustrated in FIG. 4, the head unit 56 may be configured to be able to be maintained obliquely with respect to an axis Ax parallel to the width direction of the magnetic tape MT at the time of recording and reproducing data. Alternatively, the head unit 56 may be configured to be inclined with respect to the axis Ax following the meandering or deformation of the magnetic tape MT at the time of recording and reproducing data. The inclination angle of the head unit 56 based on the axis Ax parallel to the width direction of the magnetic tape MT is preferably 3° or more and 18° or less, and more preferably 5° or more and 15° or less.

An upper limit value of a ratio R_{S}(=(S_{SB}/S)×100) of a total area S_{SB} of the plurality of servo bands SB to an area S of the magnetic surface (surface of the magnetic layer 43 side) is preferably 4.0% or less, more preferably 3.5% or less, and still more preferably 3.0% or less from a viewpoint of securing a high recording capacity. On the other hand, a lower limit value of the ratio R_{S} of the total area S_{SB} of the plurality of servo bands SB to the area S of the magnetic surface is preferably 1.0% or more from a viewpoint of securing five or more servo bands SB.

The ratio R_{S} of the total area S_{SB} of the plurality of servo bands SB to the area S of the entire magnetic surface is obtained as follows. The magnetic tape MT is developed using a ferri-colloid developer (Sigmarker Q, produced by Sigma Hi-Chemical), then the developed magnetic tape MT is observed under an optical microscope, to measure a servo band width W_{SB} and the number of the servo bands SB. Next, the ratio R_{S} is obtained from the following formula.

Ratio R_{S} [%]=(((servo band width W_{SB})×(number of servo bands SB))/(width of magnetic tape MT))×100

The number of servo bands SB is, for example, 5+4n (where n is an integer of 0 or more) or more. The number of servo bands SB is preferably 5 or more, and more preferably 9 or more. When the number of servo bands SB is 5 or more, an effect of a dimensional change in the width direction of the magnetic tape MT on the servo signal is suppressed, and stable recording/reproducing characteristics with smaller off-track can be secured. An upper limit value of the number of servo bands SB is not especially limited, but is, for example, 33 or less.

The number of servo bands SB is obtained similarly to the above method of calculating the ratio R_{S}.

An upper limit value of the servo band width W_{SB} is preferably 95 μm or less, more preferably 65 μm or less, and still more preferably 50 μm or less from a viewpoint of securing the high recording capacity. A lower limit value of the servo band width W_{SB} is preferably 10 μm or more. It is difficult to manufacture a magnetic head capable of reading a servo signal having a servo band width W_{SB} of less than 10 μm.

The width of the servo band width W_{SB} is obtained similarly to the above method of calculating the ratio R_{S}.

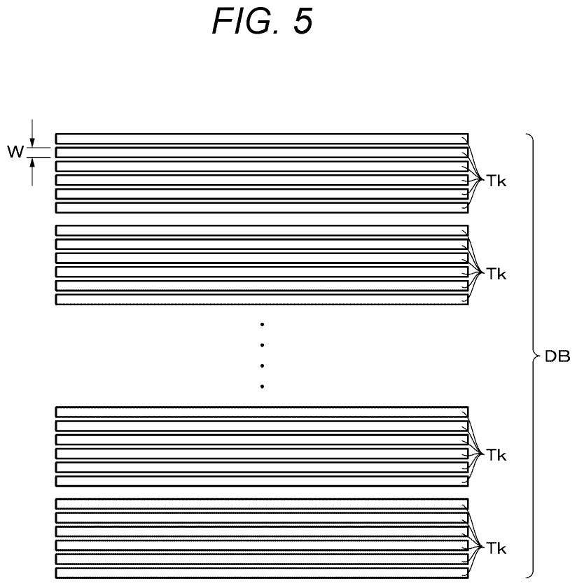

The magnetic layer 43 is configured to be able to form a plurality of data tracks Tk in the data band DB, as illustrated in FIG. 5. An upper limit value of the data track width W is preferably 1200 nm or less, more preferably 1000 nm or less, and still more preferably 850 nm or less, 800 nm or less, or 600 nm or less from a viewpoint of improving a track recording density and securing a high recording capacity. A lower limit value of the data track width W is preferably 20 nm or more in consideration of a magnetic particle size.

The data track width W is obtained as follows. First, the cartridge 10 in which data is recorded on the entire surface of the magnetic tape MT is prepared, the magnetic tape MT is unwound from the cartridge 10, and the magnetic tape MT is cut out to a length of 250 mm at a position of 30 m to 40 m in the longitudinal direction from one end of the outer peripheral side of the magnetic tape MT, thereby preparing a sample. Subsequently, a data recording pattern of a data band DB portion of the magnetic layer 43 of the sample is observed using a magnetic force microscope (MFM) to obtain an MFM image. As the MFM, Dimension3100 manufactured by Digital Instruments, Inc. and its analysis software are used. A measurement region for the MFM image is 10 μm×10 μm, and the measurement region of 10 μm×10 μm is divided into 512×512(=262,144) measurement points. Measurement by MFM is conducted for three 10 μm×10 μm measurement regions at different locations, and, thus, three MFM images are obtained. The track width is measured at 10 points in each of the obtained 3 MFM images, the measured values at 30 points in total are acquired, and the average value (simple average) of the measured values at 30 points is calculated. The average value is the data track width W. For the measurement of the track width, analysis software attached to Dimension3100 is used. Note that measurement conditions for the MFM described above are scanning speed: 1 Hz, chip used: MFMR-20, lift height: 20 nm, and correction: Flatten order 3.

The magnetic layer 43 is configured to be able to record the data so that a minimum value Lₘᵢₙ of a distance between magnetization reversals is preferably 47 nm or less, more preferably 44 nm or less, still more preferably 42 nm or less, and particularly preferably 40 nm or less from a viewpoint of securing a high recording capacity. A lower limit value of the minimum value Lₘᵢₙ of the distance between magnetization reversals is preferably 20 nm or more in consideration of the magnetic particle size.

The minimum value Lₘᵢₙ of the distance between magnetization reversals is obtained as follows. First, a sample is prepared in a similar manner to the method of measuring the data track width W. Subsequently, a data recording pattern of a data band DB portion of the magnetic layer 43 of the sample is observed using a magnetic force microscope (MFM) to obtain an MFM image. As the MFM, Dimension3100 manufactured by Digital Instruments, Inc. and its analysis software are used. A measurement region for the MFM image is 2 μm×2 μm, and the measurement region of 2 μm×2 μm is divided into 512×512(=262,144) measurement points. Measurement by MFM is conducted for three 2 μm×2 μm measurement regions at different locations, and, thus, three MFM images are obtained. From two-dimensional rugged charts of record patterns of the MFM images thus obtained, the distance between bits is measured at 50 locations. The measurement of the distance between bits is conducted using the analysis software attached to Dimension3100. A value approximately equal to the greatest common divisor of the measured 50 distances between bits is made to be the minimum value Lₘᵢₙ of the distance between magnetization reversals. Note that measurement conditions are scanning speed: 1 Hz, chip used: MFMR-20, lift height: 20 nm, and correction: Flatten order 3.

A bit length L_{bit} of the signal recorded in the data band DB is preferably 47 nm or less or 46 nm or less, more preferably 44 nm or less, still more preferably 42 nm or less, and particularly preferably 40 nm or less from a viewpoint of improving the recording density of the magnetic tape MT.

The bit length L_{bit} of the signal recorded in the data band DB is obtained in a similar manner to the method of measuring the minimum value Lₘᵢₙ of the distance between magnetization inversions.

The bit area of the signal recorded in the data band DB is preferably 53000 nm² or less, more preferably 45000 nm² or less, still more preferably 37000 nm² or less, and particularly preferably 30000 nm² or less from a viewpoint of improving the recording density of the magnetic tape MT.

The bit area of the signal recorded in the data band DB is obtained as follows. First, three MFM images are obtained similarly to the method of measuring the data track width W. Next, the data track width W and the bit length L_{bit} are obtained in a similar manner to the method of measuring the data track width W and the method of measuring the bit length L_{bit}. Next, the bit area (W×L_{bit}) of the signal recorded in the data band DB is obtained using the data track width W and the bit length L_{bit}.

The servo pattern is a magnetization region, and is formed by magnetizing a specific region of the magnetic layer 43 in a specific direction by a servo write head at the time of manufacturing the magnetic tape. In the servo band SB, a region where no servo pattern is formed (hereinafter, referred to as a “non-pattern region”) may be a magnetized region where the magnetic layer 43 is magnetized or a non-magnetized region where the magnetic layer 43 is not magnetized. In a case where the non-pattern region is the magnetization region, the servo pattern-formed region and the non-pattern region are magnetized in different directions (for example, opposite directions).

In the LTO standard, as illustrated in FIG. 6, a servo pattern including a plurality of servo stripes (linear magnetization regions) 113 inclined with respect to an axis Ax parallel to the width direction of the magnetic tape MT is formed on the servo band SB.

The servo band SB includes a plurality of servo frames 110. Each of the servo frames 110 includes eighteen servo stripes 113. Specifically, each of the servo frames 110 includes a servo subframe 1 (111) and a servo subframe 2 (112).

The servo subframe 1 (111) includes an A burst 111A and a B burst 111B. The B burst 111B is disposed adjacent to the A burst 111A. The A burst 111A includes five servo stripes 113 inclined at a predetermined angle θ₁ with respect to the axis Ax parallel to the width direction of the magnetic tape MT and formed at specified intervals. In FIG. 6, these five servo stripes 113 are denoted by reference signs A₁, A₂, A₃, A₄, and A₅ from an end of tape (EOT) to a beginning of tape (BOT) of the magnetic tape MT.

The B burst 111B includes five servo stripes 113 inclined at a predetermined angle θ₂ with respect to the axis Ax parallel to the width direction of the magnetic tape MT and formed at specified intervals. In FIG. 6, these five servo stripes 113 are denoted by reference signs B₁, B₂, B₃, B₄, and B₅ from the EOT to the BOT of the magnetic tape MT.

The servo stripes 113 of the B burst 111B are inclined in a direction opposite to the servo stripes 113 of the A burst 111A. The servo stripes 113 of the A burst 111A and the servo stripes 113 of the B burst 111B have asymmetry with respect to the axis Ax parallel to the width direction of the magnetic tape MT. That is, the servo stripes 113 of the A burst 111A and the servo stripes 113 of the B burst 111B are disposed in a roughly chevron shape. Since the servo stripes 113 of the A burst 111A and the servo stripes 113 of the B burst 111B have asymmetry with respect to the axis Ax, when the head unit 56 is inclined obliquely with respect to the axis Ax, there is a state in which the servo stripes 113 of the A burst 111A and the servo stripes 113 of the B burst 111B are substantially symmetrical with respect to the central axis of the sliding surface of the head unit 56. By changing the inclination of the head unit 56 with reference to this state, the distance between the servo read heads 56A and 56B in the width direction of the magnetic tape MT can be adjusted. Therefore, in both the case where the width of the magnetic tape MT is increased and the case where the width of the magnetic tape MT is decreased, the servo read heads 56A and 56B can be opposed to the specified positions of the servo bands SB. Note that the central axis of the sliding surface of the head unit 56 means an axis passing through the centers of the plurality of servo read heads 56A and 56B on the sliding surface of the head unit 56.

The predetermined angle θ₁ that is an inclination angle of the servo stripe 113 of the A burst 111A is different from the predetermined angle θ₂ that is an inclination angle of the servo stripe 113 of the B burst 111B. More specifically, the predetermined angle θ₁ of the servo stripe 113 of the A burst 111A may be larger than the predetermined angle θ₂ of the servo stripe 113 of the B burst 111B, or the predetermined angle θ₂ of the servo stripe 113 of the B burst 111B may be larger than the predetermined angle θ₁ of the servo stripe 113 of the A burst 111A. That is, the inclination of the servo stripe 113 of the A burst 111A may be larger than the inclination of the servo stripe 113 of the B burst 111B, or the inclination of the servo stripe 113 of the B burst 111B may be larger than the inclination of the servo stripe 113 of the A burst 111A. Note that FIG. 6 illustrates an example in which the predetermined angle θ₁ of the servo stripe 113 of the A burst 111A is larger than the predetermined angle θ₂ of the servo stripe 113 of the B burst 111B. Hereinafter, a case where the predetermined angle θ₁ of the servo stripe 113 of the A burst 111A is larger than the predetermined angle θ₂ of the servo stripe 113 of the B burst 111B will be described.

The servo subframe 2 (112) includes a C burst 112C and a D burst 112D. The D burst 112D is disposed adjacent to the C burst 112C. The C burst 112C includes four servo stripes 113 inclined at the predetermined angle θ₁ with respect to the axis Ax parallel to the width direction of the magnetic tape MT and formed at specified intervals. In FIG. 6, these four servo stripes 113 are denoted by reference signs C₁, C₂, C₃, and C₄ from the EOT to the BOT of the magnetic tape MT.

The D burst 112D includes four servo stripes 113 inclined at the predetermined angle θ₂ with respect to the axis Ax parallel to the width direction of the magnetic tape MT and formed at specified intervals. In FIG. 6, these four servo stripes 113 are denoted by reference signs D₁, D₂, D₃, and D₄ from the EOT to the BOT of the magnetic tape MT.

The servo stripes 113 of the D burst 112D are inclined in a direction opposite to the servo stripes 113 of the C burst 112C. The servo stripes 113 of the C burst 112C and the servo stripes 113 of the D burst 112D have asymmetry with respect to the axis Ax parallel to the width direction of the magnetic tape MT. That is, the servo stripes 113 of the C burst 112C and the servo stripes 113 of the D burst 112D are disposed in a roughly chevron shape. Since the servo stripes 113 of the C burst 112C and the servo stripes 113 of the D burst 112D have asymmetry with respect to the axis Ax, when the head unit 56 is inclined obliquely with respect to the axis Ax, there is a state in which the servo stripes 113 of the C burst 112C and the servo stripes 113 of the D burst 112D are substantially symmetrical with respect to the central axis of the head unit 56. The inter-servo distance can be adjusted by changing the inclination of the head unit 56 with reference to this state.

The predetermined angle θ₁ that is an inclination angle of the servo stripe 113 of the C burst 112C is different from the predetermined angle θ₂ that is an inclination angle of the servo stripe 113 of the D burst 112D. More specifically, the predetermined angle θ₁ of the servo stripe 113 of the C burst 112C may be larger than the predetermined angle θ₂ of the servo stripe 113 of the D burst 112D, or the predetermined angle θ₂ of the servo stripe 113 of the D burst 112D may be larger than the predetermined angle θ₁ of the servo stripe 113 of the C burst 112C. That is, the inclination of the servo stripe 113 of the C burst 112C may be larger than the inclination of the servo stripe 113 of the D burst 112D, or the inclination of the servo stripe 113 of the D burst 112D may be larger than the inclination of the servo stripe 113 of the C burst 112C. Note that FIG. 6 illustrates an example in which the predetermined angle θ₁ of the servo stripe 113 of the C burst 112C is larger than the predetermined angle θ₂ of the servo stripe 113 of the D burst 112D. Hereinafter, a case where the predetermined angle θ₁ of the servo stripe 113 of the C burst 112C is larger than the predetermined angle θ₂ of the servo stripe 113 of the D burst 112D will be described.

The predetermined angle θ₁ of the servo stripe 113 in the A burst 111A and the C burst 112C is preferably 180 or more and 28° or less, and more preferably 18° or more and 26° or less. The predetermined angle θ₂ of the servo stripe 113 in the B burst 111B and the D burst 112D is preferably −4° or more and 6° or less, and more preferably −2° or more and 6° or less. The servo stripe 113 in the A burst 111A and the C burst 112C is an example of a first magnetization region. The servo stripe 113 in the B burst 111B and the D burst 112D is an example of a second magnetization region.

By reading the servo band SB with the head unit 56, information for acquiring a tape speed and a position of the head unit 56 in a vertical direction can be obtained. The tape speed is calculated from the time between four timing signals (A1-C1, A2-C2, A3-C3, A4-C4). The head position is calculated from the time between the four timing signals described above and the time between another four timing signals (A1-B1, A2-B2, A3-B3, A4-B4). The servo pattern may have a shape including two parallel lines.

As illustrated in FIG. 6, the servo patterns (that is, the plurality of servo stripes 113) are preferably linearly arranged in the longitudinal direction of the magnetic tape MT. That is, the servo band SB preferably has a linear shape in the longitudinal direction of the magnetic tape MT.

An upper limit value of an average thickness t₁ of the magnetic layer 43 is preferably 80 nm or less, more preferably 70 nm or less, still more preferably 60 nm or less, and particularly preferably 50 nm or less. When the upper limit value of the average thickness t₁ of the magnetic layer 43 is 80 nm or less, an influence of a demagnetizing field can be reduced in a case where a ring type head is used as a recording head, and therefore more excellent electromagnetic conversion characteristics can be obtained.

A lower limit value of the average thickness t₁ of the magnetic layer 43 is preferably 35 nm or more. When the lower limit value of the average thickness t₁ of the magnetic layer 43 is 35 nm or more, an output can be secured in a case where an MR head is used as a reproducing head, and therefore more excellent electromagnetic conversion characteristics can be obtained.

The average thickness t₁ of the magnetic layer 43 is obtained as follows. First, the magnetic tape MT accommodated in the cartridge 10 is unwound, and the magnetic tape MT is cut out into a length of 250 mm from each of a position of 10 m to 20 m, a position of 30 m to 40 m, and a position of 50 m to 60 m in the longitudinal direction from one end on an outer peripheral side of the magnetic tape MT to prepare three samples. Subsequently, each sample is processed by a FIB method or the like to perform thinning. In a case where the FIB method is used, formation of a carbon layer and a tungsten layer as protective films is performed as pre-processing for observing a TEM image of a cross section described below. The carbon layer is formed on a surface on the magnetic layer 43 side and a surface on the back layer 44 side of the magnetic tape MT by a vapor deposition method, and then the tungsten layer is further formed on the surface of the magnetic layer 43 by a vapor deposition method or a sputtering method. The thinning is performed in the longitudinal direction of the magnetic tape MT. That is, a cross section parallel to both the longitudinal direction and the thickness direction of the magnetic tape MT is formed by the thinning.

The above-described obtained cross section of each thinned sample is observed with a transmission electron microscope (TEM) under the following conditions, and thus a TEM image of each thinned sample is obtained. Note that the magnification and the acceleration voltage may be appropriately adjusted according to the type of the device.
Device: TEM (H9000NAR manufactured by Hitachi, Ltd.)
Acceleration voltage: 300 kV
Magnification: 100,000 times

Next, the thickness of the magnetic layer 43 is measured at ten positions of each resulting thinned sample using the obtained TEM image of each thinned sample. Note that the ten measurement positions of each thinned sample are randomly selected from the sample so as to be different positions in the longitudinal direction of the magnetic tape MT. An average value obtained by simply averaging (arithmetically averaging) the obtained measured values (the thicknesses of the magnetic layers 43 at thirty points in total) of each thinned sample is defined as an average thickness t₁ [nm] of the magnetic layer 43.

### (Magnetic Particles)

The magnetic particles are, for example, particles containing hexagonal ferrite (hereinafter, referred to as “hexagonal ferrite particles”), particles containing epsilon-type iron oxide (ε-iron oxide) (hereinafter, referred to as “ε-iron oxide particles”), or particles containing Co-containing spinel ferrite (hereinafter, referred to as “cobalt ferrite particles”). The magnetic particles are preferably crystal oriented preferentially in the vertical direction of the magnetic tape MT. In the present specification, the vertical direction (thickness direction) of the magnetic tape MT means the thickness direction of the magnetic tape MT in a planar state.

### (Hexagonal Ferrite Particles)

The hexagonal ferrite particles have, for example, a plate-like shape such as a hexagonal plate-like shape or a columnar shape such as a hexagonal columnar shape (however, the thickness or height is smaller than the major axis of the plate surface or the bottom surface). In the present specification, the hexagonal plate-like shape includes a substantially hexagonal plate-like shape. However, hexagonal ferrite contains preferably at least one type selected from the group consisting of Ba, Sr, Pb, and Ca, and more preferably at least one type selected from the group consisting of Ba and Sr. Specifically, the hexagonal ferrite may be, for example, barium ferrite or strontium ferrite. The barium ferrite may further contain at least one type selected from the group consisting of Sr, Pb, and Ca, in addition to Ba. The strontium ferrite may further contain at least one type selected from the group consisting of Ba, Pb, and Ca, in addition to Sr.

More specifically, the hexagonal ferrite has an average composition represented by general formula MFe₁₂O₁₉. However, M is, for example, at least one type of metal selected from the group consisting of Ba, Sr, Pb, and Ca, and preferably at least one metal selected from the group consisting of Ba and Sr. M may be a combination of Ba and at least one type of metal selected from the group consisting of Sr, Pb, and Ca. Furthermore, M may be a combination of Sr and at least one type of metal selected from the group consisting of Ba, Pb, and Ca. A part of Fe in the above-described general formula may be substituted with another metal element.

In a case where the magnetic particles are hexagonal ferrite particles, an upper limit value of an average particle size of the magnetic particles is preferably 20 nm or less, more preferably 19 nm or less, and still more preferably 18 nm or less, 17 nm or less, or 16 nm or less. When the upper limit value of the average particle size of the magnetic particles is 20 nm or less, more excellent electromagnetic conversion characteristics (for example, SNR) can be obtained in the magnetic tape MT of high recording density.

In a case where the magnetic particles are hexagonal ferrite particles, a lower limit value of the average particle size of the magnetic particles is preferably 13 nm or more, and more preferably 14 nm or more. On the other hand, when the lower limit value of the average particle size of the magnetic particles is 13 nm or more, the dispersibility of the magnetic particles is further improved, and more excellent electromagnetic conversion characteristics (for example, SNR) can be obtained.

In a case where the magnetic particles are hexagonal ferrite particles, a numerical range of the average particle size of the magnetic particles may be defined by any of the upper limit values described above and any of the lower limit values described above, and is preferably 13 nm or more and 20 nm or less, more preferably 13 nm or more and 19 nm or less, and still more preferably 13 nm or more and 18 nm or less, 14 nm or more and 17 nm or less, or 14 nm or more and 16 nm or less.

In a case where the magnetic particles are hexagonal ferrite particles, an average aspect ratio of the magnetic particles is preferably 1.0 or more and 3.0 or less, more preferably 1.5 or more and 2.8 or less, and still more preferably 1.8 or more and 2.7 or less. When the average aspect ratio of the magnetic particles is within the range of 1.0 or more and 3.0 or less, aggregation of the magnetic particles can be suppressed. Furthermore, when the magnetic particles are vertically oriented in a process of forming the magnetic layer 43, resistance applied to the magnetic particles can be suppressed. Therefore, vertical orientation of the magnetic particles can be improved.

In a case where the magnetic particles are hexagonal ferrite particles, the average particle size and the average aspect ratio of the magnetic particles are obtained as follows. First, the magnetic tape MT accommodated in the cartridge 10 is unwound, and the magnetic tape MT is cut out at a position of 30 m to 40 m in the longitudinal direction from one end on the outer peripheral side of the magnetic tape MT. Subsequently, the magnetic tape MT to be measured is processed into a thin piece by an FIB method or the like. In a case where the FIB method is used, formation of a carbon layer and a tungsten layer as protective films is performed as pre-processing for observing a TEM image of a cross section described below. The carbon layer is formed on a surface on the magnetic layer 43 side and a surface on the back layer 44 side of the magnetic tape MT by a vapor deposition method, and then the tungsten layer is further formed on the surface of the magnetic layer 43 by a vapor deposition method or a sputtering method. The thinning is performed in a length direction (longitudinal direction) of the magnetic tape MT. That is, a cross section parallel to both the longitudinal direction and the thickness direction of the magnetic tape MT is formed by the thinning.

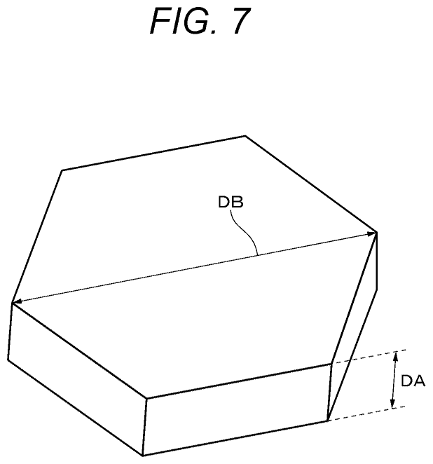

Using a transmission electron microscope (H-9500 manufactured by Hitachi High-Technologies Corporation), the cross section described above of the obtained thin piece sample is observed at an acceleration voltage of 200 kV and a total magnification of 500,000 times so that the entire magnetic layer 43 is included in the thickness direction of the magnetic layer 43, and a TEM image is captured. As the TEM image, the number of sheets capable of extracting fifty particles capable of measuring a plate diameter DB and a plate thickness DA (see FIG. 7) illustrated below is prepared.

In the present specification, as for the size of the hexagonal ferrite particles (hereinafter, referred to as “particle size”), in a case where the shape of the particles observed in the TEM image described above is a plate shape or a columnar shape (however, the thickness or height is smaller than the major axis of the plate surface or the bottom surface) as illustrated in FIG. 7, the major axis of the plate surface or the bottom surface is taken as the value of the plate diameter DB. The thickness or height of the particles observed in the TEM image described above is defined as the value of the plate thickness DA. In a case where a thickness or a height of a particle is not constant within one particle observed in the TEM image, the thickness or height of the maximum particle is taken as the plate thickness DA.

Next, fifty particles extracted from the captured TEM image are selected on the basis of the following criteria. A particle whose part of the particle protrudes outside the field of view of the TEM image is not measured, and a particle whose outline is clear and which exists in isolation is measured. In a case where particles overlap, each particle is to be measured as a single particle when the boundary between the particles is clear and the entire shape of each particle can be determined, but a particle in which the boundary is not clear and the entire shape of the particle cannot be determined is not to be measured as the shape of the particle cannot be determined.

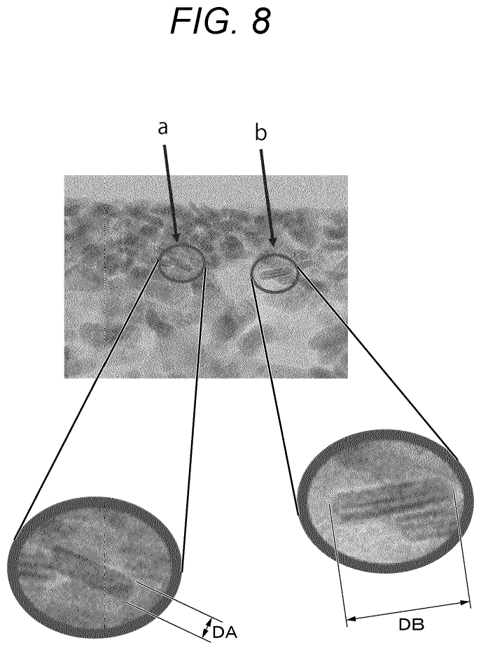

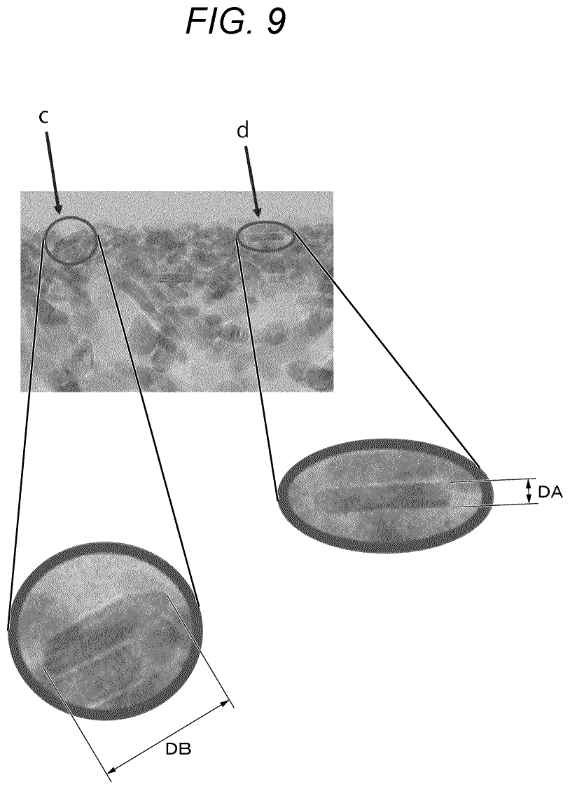

FIGS. 8 and 9 illustrate a first example and a second example of the TEM image, respectively. In FIGS. 8 and 9, for example, the particles indicated by arrows a and d are selected because the plate thickness (thickness or height of the particles) DA of the particles can be clearly confirmed. The plate thickness DA of each of the selected 50 particles is measured. The plate thicknesses DA thus obtained are simply averaged (arithmetically averaged) to obtain an average plate thickness DAₐᵥₑ. The average plate thickness DAₐᵥₑ is an average particle plate thickness. Subsequently, the plate diameter DB of each magnetic particle is measured. In order to measure the plate diameter DB of the particle, fifty particles for which the plate diameter DB of the particle can be clearly confirmed are selected from the captured TEM image. For example, in FIGS. 8 and 9, for example, the particles indicated by arrows b and c are selected because the plate diameter DB of the particles can be clearly confirmed. The plate diameter DB of each of the selected 50 particles is measured. The plate diameters DB thus obtained are simply averaged (arithmetically averaged) to obtain an average plate diameter DBₐᵥₑ. The average plate diameter DBₐᵥₑ is an average particle size. Then, an average aspect ratio (DBₐᵥₑ/DAₐᵥₑ) of the particle is obtained from the average plate thickness DAₐᵥₑ and the average plate diameter DBₐᵥₑ.

In a case where the magnetic particles are hexagonal ferrite particles, an upper limit value of an average particle volume of the magnetic particles is preferably 2500 nm³ or less, more preferably 1800 nm³ or less, and still more preferably 1500 nm³ or less, 1400 nm³ or less, 1200 nm³ or less, or 1000 nm³ or less. When the upper limit value of the average particle volume of the magnetic particles is 2500 nm³ or less, an effect similar to that in a case where the average particle size of the magnetic particles is 20 nm or less can be obtained.

In a case where the magnetic particles are hexagonal ferrite particles, a lower limit value of the average particle volume of the magnetic particles is preferably 500 nm³ or more, and more preferably 600 nm³ or more. When the average particle volume of the magnetic particles is 500 nm³ or more, an effect similar to that in a case where the average particle size of the magnetic particles is 13 nm or more can be obtained.

In a case where the magnetic particles are hexagonal ferrite particles, a numerical range of the average particle volume of the magnetic particles may be defined by any of the upper limit values described above and any of the lower limit values described above, and is preferably 500 nm³ or more and 2500 nm³ or less, more preferably 500 nm³ or more and 1800 nm³ or less, and still more preferably 500 nm³ or more and 1500 nm³ or less, 500 nm³ or more and 1400 nm³ or less, 600 nm³ or more and 1200 nm³ or less, or 600 nm³ or more and 1000 nm³ or less.

The average particle volume of the magnetic particles is obtained as follows. First, as described above regarding the above-described method of calculating the average particle size of the magnetic particles, the average plate thickness DAₐᵥₑ and the average plate diameter DBₐᵥₑ are obtained. Next, an average volume V of the magnetic particles is obtained by the following formula.

$$V = \frac{3 \sqrt{3}}{8} \times {DA}_{ave} \times {DB}_{ave} \times {DB}_{ave} \qquad [ Mathematical formula 1 ]$$

### (ε-Iron Oxide Particles)

The ε-iron oxide particles are hard magnetic particles capable of obtaining a high coercive force even with fine particles. The ε-iron oxide particles have a spherical shape or a cubic shape. In the present specification, the spherical shape includes a substantially spherical shape. Furthermore, the cubic shape includes a substantially cubic shape. Since the ε-iron oxide particles have the shape as described above, in a case where ε-iron oxide particles are used as the magnetic particles, a contact area between the particles in the thickness direction of the magnetic tape MT can be reduced and aggregation of the particles can be suppressed as compared with a case where barium ferrite particles having a hexagonal plate shape are used as the magnetic particles. Therefore, dispersibility of the magnetic particles is increased, and more excellent electromagnetic conversion characteristics (for example, SNR) can be obtained.

The ε-iron oxide particles may have a structure of composite particles. More specifically, the ε-iron oxide particle includes an ε-iron oxide portion and a portion having soft magnetism or a portion having magnetism in which a saturation magnetization amount σs is higher than that of ε-iron oxide and a coercive force Hc is smaller than that of ε-iron oxide (hereinafter, referred to as a “portion having soft magnetism or the like”).

The ε-iron oxide portion contains ε-iron oxide. The ε-iron oxide contained in the ε-iron oxide portion preferably includes an ε-Fe₂O₃ crystal as a main phase, and more preferably includes a single-phase ε-Fe₂O₃.

The portion having soft magnetism or the like is in contact with at least a part of the ε-iron oxide portion. Specifically, the portion having soft magnetism or the like may partially cover the ε-iron oxide portion, and may partially cover an entire periphery of the ε-iron oxide portion.

The portion having soft magnetism (portion having magnetism in which the saturation magnetization amount σs is higher than that of ε-iron oxide and the coercive force Hc is smaller than that of ε-iron oxide) contains, for example, a soft magnetic material such as α-Fe, a Ni—Fe alloy, an Fe—Si—Al alloy, or the like. α-Fe may be obtained by reducing the ε-iron oxide contained in the ε-iron oxide portion.

Furthermore, the portion having soft magnetism may contain, for example, Fe₃O₄, γ-Fe₂O₃, spinel ferrite, or the like.

The ε-iron oxide particle includes the portion having soft magnetism described above or the like, such that the coercive force Hc of the ε-iron oxide particles (composite particles) as a whole can be adjusted to a coercive force Hc suitable for recording while maintaining the coercive force Hc of the ε-iron oxide portion alone at a large value in order to ensure thermal stability.

The ε-iron oxide particles may contain an additive instead of the structure of the composite particles described above, or may have the structure of the composite particles and may contain an additive as well. In this case, a part of Fe of the ε-iron oxide particles is replaced with an additive. Since the coercive force Hc of the entire ε-iron oxide particles can be adjusted to the coercive force Hc suitable for recording also when the ε-iron oxide particle contains the additive, the ease of recording can be improved. The additive is a metal element other than iron, preferably a trivalent metal element, more preferably at least one type selected from the group consisting of Al, Ga, and In, and still more preferably at least one type selected from the group consisting of Al and Ga.

Specifically, the ε-iron oxide containing the additive is an ε-Fe₂₋ₓMₓO₃ crystal (where M is a metal element other than iron, preferably a trivalent metal element, more preferably at least one type selected from the group consisting of Al, Ga, and In, and still more preferably at least one type selected from the group consisting of Al and Ga, and x is, for example, 0<x<1).

In a case where the magnetic particles are ε-iron oxide particles, the upper limit value of the average particle size of the magnetic particles is preferably 20 nm or less, more preferably 18 nm or less, and still more preferably 16 nm or less, 15 nm or less, or 14 nm or less. In the magnetic tape MT, a region having a size of ½ of a recording wavelength is an actual magnetization region. Therefore, more excellent electromagnetic conversion characteristics (for example, SNR) can be obtained by setting the average particle size of the magnetic particles to half or less of the shortest recording wavelength. Accordingly, when the upper limit value of the average particle size of the magnetic particles is 20 nm or less, in the magnetic tape MT having a high recording density (for example, the magnetic tape MT configured to be able to record a signal at the shortest recording wavelength of 40 nm or less), more excellent electromagnetic conversion characteristics (for example, SNR) can be obtained.

In a case where the magnetic particles are ε-iron oxide particles, the lower limit value of the average particle size of the magnetic particles is preferably 10 nm or more. When the lower limit value of the average particle size of the magnetic particles is 10 nm or more, the dispersibility of the magnetic particles is further improved, and more excellent electromagnetic conversion characteristics (for example, SNR) can be obtained.

In a case where the magnetic particles are ε-iron oxide particles, a numerical range of the average particle size of the magnetic particles may be defined by any of the upper limit values described above and any of the lower limit values described above, and is preferably 10 nm or more and 20 nm or less, more preferably 10 nm or more and 18 nm or less, and still more preferably 10 nm or more and 16 nm or less, 10 nm or more and 15 nm or less, or 10 nm or more and 14 nm or less.

In a case where the magnetic particles are ε-iron oxide particles, an average aspect ratio of the magnetic particles is preferably 1.0 or more and 3.0 or less, more preferably 1.0 or more and 2.5 or less, and still more preferably 1.0 or more and 2.1 or less, or 1.0 or more and 1.8 or less. When the average aspect ratio of the magnetic particles is within the range of 1.0 or more and 3.0 or less, aggregation of the magnetic particles can be suppressed. Furthermore, when the magnetic particles are vertically oriented in a process of forming the magnetic layer 43, resistance applied to the magnetic particles can be suppressed. Therefore, vertical orientation of the magnetic particles can be improved.

In a case where the magnetic particles are ε-iron oxide particles, the average particle size and the average aspect ratio of the magnetic particles are obtained as follows. First, the magnetic tape MT accommodated in the cartridge 10 is unwound, and the magnetic tape MT is cut out at a position of 30 m to 40 m in the longitudinal direction from one end on the outer peripheral side of the magnetic tape MT. Subsequently, the magnetic tape MT to be measured is processed by a focused ion beam (FIB) method or the like to be thinned. In a case where the FIB method is used, a carbon layer and a tungsten layer are formed as protective layers as a pre-treatment for observing a TEM image of a cross section described later. The carbon layer is formed on a surface on the magnetic layer 43 side and a surface on the back layer 44 side of the magnetic tape MT by a vapor deposition method, and then the tungsten layer is further formed on the surface of the magnetic layer 43 by a vapor deposition method or a sputtering method. The thinning is performed in the length direction (longitudinal direction) of the magnetic tape MT. That is, a cross section parallel to both the longitudinal direction and the thickness direction of the magnetic tape MT is formed by the thinning.

Using a transmission electron microscope (H-9500 manufactured by Hitachi High-Technologies Corporation), the cross section described above of the obtained thin piece sample is observed at an acceleration voltage of 200 kV and a total magnification of 500,000 times so that the entire magnetic layer 43 is included in the thickness direction of the magnetic layer 43, and a TEM image is captured. Next, 50 particles whose shapes can be clearly confirmed are selected from the captured TEM image, and a long axis length DL and a short axis length DS of each particle are measured. Here, the long axis length DL means the largest one of the distances between two parallel lines drawn from all angles so as to be in contact with a contour of each particle (so-called maximum Feret's diameter). Meanwhile, the short axis length DS means the largest one of the lengths of a particle in a direction orthogonal to the long axis (DL) of the particle. Subsequently, the measured long axis lengths DL of the 50 particles are simply averaged (arithmetically averaged) to obtain an average long axis length DLₐᵥₑ. The average long axis length DLₐᵥₑ obtained as described above is defined as the average particle size of the magnetic particles. Furthermore, the measured short axis lengths DSs of the 50 particles are simply averaged (arithmetically averaged) to determine an average short axis length DSₐᵥₑ. Then, an average aspect ratio (DLₐᵥₑ/DSₐᵥₑ) of the particles is obtained from the average long axis length DLₐᵥₑ and the average short axis length DSₐᵥₑ.

In a case where the magnetic particles are ε-iron oxide particles, the upper limit value of the average particle volume of the magnetic particles is preferably 4000 nm³ or less, more preferably 3000 nm³ or less, and still more preferably 2000 nm³ or less, 1600 nm³ or less, or 1300 nm³ or less. In general, since a noise of the magnetic tape MT is inversely proportional to a square root of the number of particles (that is, proportional to the square root of the particle volume), more excellent electromagnetic conversion characteristics (for example, SNR) can be obtained by reducing the particle volume. Therefore, when the upper limit value of the average particle volume of the magnetic particles is 4000 nm³ or less, similarly to a case where the average particle size of the magnetic particles is 20 nm or less, more excellent electromagnetic conversion characteristics (for example, SNR) can be obtained.

In a case where the magnetic particles are ε-iron oxide particles, the lower limit value of the average particle volume of the magnetic particles is preferably 500 nm³ or more, and more preferably 600 nm³ or more. When the lower limit value of the average particle volume of the magnetic particles is 500 nm³ or more, an effect similar to that in a case where the average particle size of the magnetic particles is 10 nm or more is obtained.

In a case where the magnetic particles are ε-iron oxide particles, a numerical range of the average particle volume of the magnetic particles may be defined by any of the upper limit values described above and any of the lower limit values described above, and is preferably 500 nm³ or more and 4000 nm³ or less, more preferably 500 nm³ or more and 3000 nm³ or less, and still more preferably 500 nm³ or more and 2000 nm³ or less, 600 nm³ or more and 1600 nm³ or less, or 600 nm³ or more and 1300 nm³ or less.

In a case where the ε-iron oxide particles have a spherical shape, the average particle volume of the magnetic particles is obtained as follows. First, the average long axis length DLₐᵥₑ is obtained in a manner similar to the method of calculating the average particle size of the magnetic particles described above. Next, an average volume V of the magnetic particles is obtained by the following formula.

$$V = ( π / 6 ) \times {DL}_{ave}^{3}$$

In a case where the ε-iron oxide particle has a cubic shape, the average volume of the magnetic particles is obtained as follows. First, the magnetic tape MT accommodated in the cartridge 10 is unwound, and the magnetic tape MT is cut out at a position of 30 m to 40 m in the longitudinal direction from one end on the outer peripheral side of the magnetic tape MT. Subsequently, the cut out magnetic tape MT is processed by a focused ion beam (FIB) method or the like to be thinned. In a case where the FIB method is used, a carbon film and a tungsten thin film are formed as protective films as a pre-treatment for observing a TEM image of a cross section described later. The carbon film is formed on a surface on the magnetic layer 43 side and a surface on the back layer 44 side of the magnetic tape MT by a vapor deposition method, and then the tungsten thin film is further formed on the surface on the magnetic layer 43 side by a vapor deposition method or a sputtering method. The thinning is performed in a length direction (longitudinal direction) of the magnetic tape MT. That is, a cross section parallel to both the longitudinal direction and the thickness direction of the magnetic tape MT is formed by the thinning.

Using a transmission electron microscope (H-9500 manufactured by Hitachi High-Technologies Corporation), the obtained thin piece sample is observed at an acceleration voltage of 200 kV and a total magnification of 500,000 times so that the entire magnetic layer 43 is included in the thickness direction of the magnetic layer 43, and a TEM image is obtained. Note that the magnification and the acceleration voltage may be appropriately adjusted according to the type of the device. Next, 50 particles whose shapes can be clearly confirmed are selected from the captured TEM image, and a side length DC of each particle is measured. Subsequently, the measured side lengths DC of the 50 particles are simply averaged (arithmetically averaged) to obtain the average side length DCₐᵥₑ. Next, an average volume Vₐᵥₑ (particle volume) of the magnetic particles is obtained from the following formula using the average side length DCₐᵥₑ.

$${V}_{a v e} = {DC}_{ave}^{3}$$

### (Cobalt Ferrite Particles)

Cobalt ferrite particles preferably have uniaxial crystal anisotropy. Since the cobalt ferrite particles have the uniaxial crystal anisotropy, the magnetic particles can be preferentially crystal-oriented in the vertical direction of the magnetic tape MT. The cobalt ferrite particles have, for example, a cubic shape. In the present specification, the cubic shape includes a substantially cubic shape. Co-containing spinel ferrite may further contain at least one type selected from the group consisting of Ni, Mn, Al, Cu, and Zn, in addition to Co.

The Co-containing spinel ferrite has, for example, an average composition represented by the following formula:

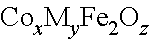

(In the formula, M is, for example, at least one type of metal selected from the group consisting of Ni, Mn, Al, Cu, and Zn. x is a value within a range of 0.4≤x≤1.0. y is a value within a range of 0≤y≤0.3. However, x and y satisfy a relationship of (x+y)≤1.0. z is a value within a range of 3≤z≤4. A part of Fe may be substituted with another metal element.)

In a case where the magnetic particles are cobalt ferrite particles, the upper limit value of the average particle size of the magnetic particles is preferably 16 nm or less, more preferably 13 nm or less, and still more preferably 10 nm or less. When the upper limit value of the average particle size of the magnetic particles is 16 nm or less, more excellent electromagnetic conversion characteristics (for example, SNR) can be obtained in the magnetic tape MT of high recording density.

In a case where the magnetic particles are cobalt ferrite particles, the lower limit value of the average particle size of the magnetic particles is preferably 8 nm or more. When the lower limit value of the average particle size of the magnetic particles is 8 nm or more, the dispersibility of the magnetic particles is further improved, and more excellent electromagnetic conversion characteristics (for example, SNR) can be obtained.

In a case where the magnetic particles are cobalt ferrite particles, a numerical range of the average particle size of the magnetic particles may be defined by any of the upper limit values described above and any of the lower limit values described above, and is preferably 8 nm or more and 16 nm or less, more preferably 8 nm or more and 13 nm or less, and still more preferably 8 nm or more and 10 nm or less. The method of calculating the average particle size of the magnetic particles is similar to the method of calculating the average particle size of the magnetic particles in a case where the magnetic particles are ε-iron oxide particles.

In a case where the magnetic particles are cobalt ferrite particles, the average aspect ratio of the magnetic particles is preferably 1.0 or more and 3.0 or less, more preferably 1.0 or more and 2.5 or less, and still more preferably 1.0 or more and 2.0 or less. When the average aspect ratio of the magnetic particles is within the range of 1.0 or more and 3.0 or less, aggregation of the magnetic particles can be suppressed. Furthermore, when the magnetic particles are vertically oriented in a process of forming the magnetic layer 43, resistance applied to the magnetic particles can be suppressed. Therefore, vertical orientation of the magnetic particles can be improved. The method of calculating the average aspect ratio of the magnetic particles is similar to the method of calculating the average aspect ratio of the magnetic particles in a case where the magnetic particles are ε-iron oxide particle powder.

In a case where the magnetic particles are cobalt ferrite particles, the upper limit value of the average particle volume of the magnetic particles is preferably 4000 nm³ or less, more preferably 2000 nm³ or less, and still more preferably 1000 nm³ or less. When the upper limit value of the average particle volume of the magnetic particles is 4000 nm³ or less, an effect similar to that in a case where the average particle size of the magnetic particles is 16 nm or less is obtained.

In a case where the magnetic particles are cobalt ferrite particles, the lower limit value of the average particle volume of the magnetic particles is preferably 500 nm³ or more, and more preferably 600 nm³ or more. When the lower limit value of the average particle volume of the magnetic particles is 500 nm³ or more, an effect similar to that in a case where the average particle size of the magnetic particles is 8 nm or more is obtained.

In a case where the magnetic particles are cobalt ferrite particles, a numerical range of the average particle volume of the magnetic particles may be defined by any of the upper limit values described above and any of the lower limit values described above, and is preferably 500 nm³ or more and 4000 nm³ or less, more preferably 600 nm³ or more and 2000 nm³ or less, and still more preferably 600 nm³ or more and 1000 nm³ or less. The method of calculating the average particle volume of the magnetic component is similar to the method of calculating the average particle volume in a case where the ε-iron oxide particles have a cubic shape.

### (Binder)

A binder contains, for example, a thermoplastic resin. The binder may further contain a thermosetting resin, a reactive resin, or the like.

The thermoplastic resin contains a first thermoplastic resin containing a chlorine atom (first binder) and a second thermoplastic resin containing a nitrogen atom (second binder). More specifically, the thermoplastic resin contains a vinyl chloride-based resin and a urethane-based resin. In the present specification, the vinyl chloride-based resin means a polymer containing a structural unit derived from vinyl chloride. More specifically, for example, the vinyl chloride-based resin means a homopolymer of vinyl chloride, a polymer of vinyl chloride and a comonomer copolymerizable therewith, and a mixture of these polymers.

The vinyl chloride-based resin includes, for example, at least one type selected from the group consisting of vinyl chloride, a vinyl chloride-vinyl acetate copolymer, a vinyl chloride-vinylidene chloride copolymer, a vinyl chloride-acrylonitrile copolymer, an acrylic acid ester-vinyl chloride-vinylidene chloride copolymer, and a methacrylic acid ester-vinyl chloride copolymer.

The urethane-based resin means a resin containing a urethane bond in at least a part of a molecular chain constituting the resin, and may be a urethane resin or a copolymer containing a urethane bond in a part of a molecular chain. The urethane-based resin may be obtained, for example, by reacting a polyisocyanate with a polyol. Alternatively, the urethane-based resin may be obtained, for example, by reacting a polyester with a polyol. In the present specification, the urethane-based resin includes those obtained by reaction with a curing agent.

The polyisocyanate includes, for example, at least one selected from the group consisting of diphenylmethane diisocyanate (MDI), tolylene diisocyanate (TDI), xylylene diisocyanate (XDI), 1,5-pentamethylene diisocyanate (PDI), hexamethylene diisocyanate (HDI), isophorone diisocyanate (IPDI), and the like. In the present specification, the polyisocyanate means a compound having two or more isocyanate groups in the molecule. The polyisocyanate may be a polyisocyanate contained in the curing agent.

As the polyol, any suitable polyol can be adopted as long as it is a polyol having two or more OH groups. The polyol includes, for example, at least one selected from the group consisting of a polyol having two OH groups (diol), a polyol having three OH groups (triol), a polyol having four OH groups (tetraol), a polyol having five OH groups (pentaol), and a polyol having six OH groups (hexaol). Specifically, the polyol includes, for example, at least one selected from the group consisting of a polyester-based polyol, a polyether-based polyol, a polycarbonate-based polyol, a polyesteramide-based polyol, an acrylate-based polyol, and the like.

The polyester contains, for example, at least one type selected from the group consisting of a phthalic acid-based polyester and an aliphatic polyester.

The thermoplastic resin may further contain a thermoplastic resin other than the vinyl chloride-based resin and the urethane-based resin. Such a thermoplastic resin contains, for example, at least one type selected from the group consisting of vinyl acetate, an acrylic acid ester-acrylonitrile copolymer, an acrylic acid ester-acrylonitrile copolymer, an acrylic acid ester-vinylidene chloride copolymer, a methacrylic acid ester-vinylidene chloride copolymer, a methacrylic acid ester-ethylene copolymer, polyvinyl fluoride, a vinylidene chloride-acrylonitrile copolymer, an acrylonitrile-butadiene copolymer, a polyamide resin, polyvinyl butyral, a cellulose derivative (cellulose acetate butyrate, cellulose diacetate, cellulose triacetate, cellulose propionate, or nitrocellulose), a styrene-butadiene copolymer, a polyester resin, an amino resin, and synthetic rubber.

The thermosetting resin contains, for example, at least one type selected from the group consisting of a phenol resin, an epoxy resin, a polyurethane curable resin, a urea resin, a melamine resin, an alkyd resin, a silicone resin, a polyamine resin, and a urea formaldehyde resin.

For the purpose of improving the dispersibility of the magnetic particles, polar functional groups such as —SO₃M, —OSO₃M, —COOM, P═O(OM)₂ (where M in the formulas represents a hydrogen atom or an alkali metal such as lithium, potassium, or sodium), a side chain type amine having an end group represented by —NR1R2 or —NR1R2R3⁺X⁻, a main chain type amine represented by >NR1R2⁺X⁻ (where R1, R2, and R3 in the formulas represent a hydrogen atom or a hydrocarbon group, and X⁻ represents a halogen element ion such as fluorine, chlorine, bromine, or iodine, an inorganic ion, or an organic ion), —OH, —SH, —CN, and an epoxy group may be introduced into all the binders described above. An amount of these polar functional groups to be introduced into the binder is preferably 10⁻¹ mol/g or more and 10⁻⁸ mol/g or less, and more preferably 10⁻² mol/g or more and 10⁻⁶ mol/g or less.

### (Carbon Particles)

Some of the carbon particles contained in the magnetic layer 43 may protrude from the magnetic surface to form a plurality of protrusions. Since the plurality of protrusions includes carbon particles, electric resistance of the magnetic surface can be reduced, and charging of the magnetic surface can be suppressed. Furthermore, dynamic friction between the head unit 56 and the magnetic surface can be reduced when the magnetic tape MT travels.

The carbon particles may function as antistatic agents and solid lubricants. The average primary particle size of the carbon particles is preferably 100 nm or less. When the average primary particle size of the carbon particles is 100 nm or less, the content of particles excessively large with respect to the thickness of the magnetic layer 43 is suppressed even in a case where the carbon particles are particles having a large particle size distribution (for example, carbon black or the like).

As the carbon particles, for example, one or more selected from the group consisting of carbon black, acetylene black, Ketjen black, carbon nanotubes, and graphene can be used, and among these carbon particles, carbon black is preferably used. As the carbon black, for example, SEAST TA manufactured by Tokai Carbon, Asahi #15 and #15HS manufactured by Asahi Carbon Co., Ltd., and the like can be used.

The magnetic layer 43 may contain hybrid particles instead of carbon particles, or may contain hybrid particles together with carbon particles. The hybrid particles contain carbon and a material other than carbon. The material other than carbon is, for example, an organic material or an inorganic material. The hybrid particles may be hybrid particles in which carbon is attached to a surface of the inorganic particle. Specifically, for example, hybrid carbons in which carbon is attached to a surface of silica particles may be used.

### (Lubricant)

The lubricant may be a liquid lubricant. The lubricant contains, for example, at least one type selected from fatty acid and fatty acid ester, and preferably both fatty acid and fatty acid ester. The fact that the magnetic layer 43 contains a lubricant, in particular, the fact that the magnetic layer 43 contains both fatty acid and fatty acid ester contributes to improvement of traveling stability of the magnetic tape MT. More particularly, since the magnetic layer 43 contains a lubricant and has pores, good traveling stability is achieved. The improvement of the traveling stability is considered to be because the dynamic friction coefficient of the magnetic layer 43 side surface of the magnetic tape MT is adjusted to a value suitable for travel of the magnetic tape MT by the lubricant described above.

The fatty acid may be preferably a compound represented by the following general Formula (1) or (2). For example, one or both of the compound represented by the following general Formula (1) and the compound represented by the general Formula (2) may be contained as the fatty acid.

Furthermore, the fatty acid ester may be preferably a compound represented by the following general Formula (3), (4) or (5). For example, the fatty acid ester may contain one, two or three types of the compounds represented by the following general Formula (3), the compounds represented by general Formula (4) and the compounds represented by general Formula (5).

With the lubricant containing either one or both of the compounds represented by general Formula (1) and the compounds represented by general Formula (2), and one, two or three types of the compounds represented by general Formula (3), the compounds represented by general Formula (4) and the compounds represented by general Formula (5), an increase in dynamic friction coefficient due to repeated recording or reproduction on the magnetic tape MT can be suppressed.

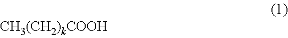

(where, in general Formula (1), k is an integer selected from a range of 14 or more and 22 or less, and more preferably a range of 14 or more and 18 or less.)

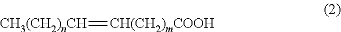

(where, in general Formula (2), the sum of n and m is an integer selected from a range of 12 or more and 20 or less, and more preferably a range of 14 or more and 18 or less.)

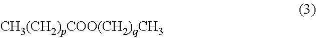

(Here, in general Formula (3), p is an integer selected from a range of 14 or more and 22 or less, and more preferably a range of 14 or more and 18 or less, and q is an integer selected from a range of 2 or more and 5 or less, and more preferably a range of 2 or more and 4 or less.)

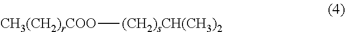

(where, in general Formula (4), r is an integer selected from a range of 14 or more and 22 or less, and s is an integer selected from a range of 1 or more and 3 or less.)

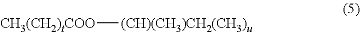

(where, in general Formula (5), t is an integer selected from a range of 14 or more and 22 or less, and u is an integer selected from a range of 1 or more and 3 or less.)

### (Abrasive Particles)

Some of the abrasive particles contained in the magnetic layer 43 may protrude from the magnetic surface to form a plurality of protrusions. When the head unit 56 and the magnetic tape MT slide, the protrusions formed by the abrasive particles are able to come into contact with the head unit 56.

A lower limit value of the Mohs hardness of the abrasive particles is preferably 7.0 or more, more preferably 7.5 or more, still more preferably 8.0 or more, and particularly preferably 8.5 or more from a viewpoint of suppressing deformation due to contact with the head unit 56. An upper limit value of the Mohs hardness of the abrasive particles is preferably 9.5 or less from a viewpoint of suppressing wear of the head unit 56.

The abrasive particles are preferably inorganic particles. Examples of the inorganic particle includes α-alumina having an a conversion rate of 90% or more, β-alumina, γ-alumina, silicon carbide, chromium oxide, cerium oxide, α-iron oxide, corundum, silicon nitride, titanium carbide, titanium oxide, silicon dioxide, tin oxide, magnesium oxide, tungsten oxide, zirconium oxide, boron nitride, zinc oxide, calcium carbonate, calcium sulfate, barium sulfate, molybdenum disulfide, acicular α-iron oxide prepared by subjecting a raw material of magnetic iron oxide to dehydration and an annealing treatment, materials obtained by subjecting these to a surface treatment with aluminum and/or silica, as required, a diamond powder, and the like. As the inorganic particles, alumina particles such as α-alumina, β-alumina, and γ-alumina, and silicon carbide are preferably used. Although the abrasive particles may have any shape such as a needle shape, a spherical shape, or a dice shape, those having a corner in a part of the shape are preferable because they have high abrasiveness.

### (Antistatic Agent)

The antistatic agent can reduce the electric resistance of the magnetic surface and suppress charging of the magnetic surface. The antistatic agent may further contain at least one type selected from the group consisting of a natural surfactant, a nonionic surfactant, a cationic surfactant, and the like.

### (Curing Agent)

The curing agent contains, for example, polyisocyanate. The polyisocyanate may contain, for example, diphenylmethane diisocyanate (MDI), tolylene diisocyanate (TDI), xylylene diisocyanate (XDI), 1,5-pentamethylene diisocyanate (PDI), hexamethylene diisocyanate (HDI), isophorone diisocyanate (IPDI), or the like as an isocyanate source. The polyisocyanate may have a TMP adduct structure, an isocyanurate structure, a biuret structure, an allophanate structure, or the like.

Specifically, the polyisocyanate contains, for example, aromatic polyisocyanates such as an adduct of tolylene diisocyanate (TDI) and an active hydrogen compound, aliphatic polyisocyanates such as an adduct of hexamethylene diisocyanate (HMDI) and an active hydrogen compound, and the like. A weight average molecular weight of these polyisocyanates is desirably in a range of 100 or more and 3000 or less.

### (Rust-Preventive Agent)

Examples of the rust-preventive agent include phenols, naphthols, quinones, heterocyclic compounds containing a nitrogen atom, heterocyclic compounds containing an oxygen atom, heterocyclic compounds containing a sulfur atom, and the like.

### (Nonmagnetic Reinforcing Particle)

Examples of the nonmagnetic reinforcing particle include aluminum oxide (α, β, or γ alumina), chromium oxide, silicon oxide, diamond, garnet, emery, boron nitride, titanium carbide, silicon carbide, titanium carbide, titanium oxide (rutile type or anatase type titanium oxide), and the like.

### (Underlayer)

The underlayer 42 relaxes the concavoconvex shape of the surface of the base 41 and adjusts the concavoconvex shape of the magnetic surface. The underlayer 42 is a nonmagnetic layer including nonmagnetic particles, a binder, and a lubricant. The underlayer 42 supplies a lubricant to the magnetic surface. The underlayer 42 may further contain at least one type of additive selected from the group consisting of an antistatic agent, a curing agent, a rust-preventive agent, and the like, as necessary.

As illustrated in FIG. 3B, the underlayer 42 may have a plurality of holes 42A. A lubricant may be stored in each of the holes 42A. In this case, a supply property of the lubricant to the magnetic surface can be improved. From a viewpoint of improving the supply property of the lubricant to the magnetic surface, it is preferable that the holes 42A are provided to extend in a direction perpendicular to the magnetic surface. From a viewpoint of improving the supply property of the lubricant to the magnetic surface, it is preferable that the hole 42A of the underlayer 42 and the hole 43A of the magnetic layer 43 are connected to each other.

An upper limit value of an average thickness t₂ of the underlayer 42 is preferably 0.90 μm or less, more preferably 0.80 μm or less, still more preferably 0.70 μm or less, and particularly preferably 0.60 μm or less. When the average thickness t₂ of the underlayer 42 is 0.90 μm or less, stretchability of the magnetic tape MT due to an external force further increases, so that adjustment of the width of the magnetic tape MT by tension adjustment is further facilitated. A lower limit value of the average thickness t₂ of the underlayer 42 is preferably 0.30 μm or more from a viewpoint of alleviating an irregularity shape on the surface of the base 41.

The average thickness t₂ of the underlayer 42 is obtained similarly to the average thickness t₁ of the magnetic layer 43. However, magnification of the TEM image is appropriately adjusted according to the thickness of the underlayer 42.

The underlayer 42 preferably includes the plurality of holes. Since the lubricant is stored in the plurality of holes, it is possible to further suppress a decrease in supply amount of the lubricant between the magnetic surface and the head unit 56 even after the repeated recording or reproduction (that is, even after the head unit 56 is brought into contact with the surface of the magnetic tape MT and repeatedly travels). Therefore, the increase in dynamic friction coefficient may be further suppressed. That is, more excellent traveling stability can be obtained.

### (Nonmagnetic Particle)

The nonmagnetic particles include, for example, at least one type of inorganic particles or organic particles. Furthermore, the nonmagnetic particles may be carbon particles such as carbon black. Note that one type of nonmagnetic particles may be used alone, or two or more types of nonmagnetic particles may be used in combination. The inorganic particles contain, for example, metal, metal oxide, metal carbonate, metal sulfate, metal nitride, metal carbide, metal sulfide and the like. A shape of the nonmagnetic particle may be, for example, various shapes such as a needle shape, a spherical shape, a cubic shape, a plate shape and the like, but is not limited these shapes.

### (Binder, Lubricant)

The binder and the lubricant are similar to that of the magnetic layer 43 described above.

### (Additive)

The antistatic agent, the curing agent, and the rust-preventive agent are each similar to those of the magnetic layer 43 described above.

### (Back Layer)

The back layer 44 contains a binder and nonmagnetic particles. The back layer 44 may further contain at least one type of additive selected from the group consisting of a lubricant, a curing agent, an antistatic agent, and the like, as necessary. The binder and the nonmagnetic particles are similar to those of the underlayer 42 described above. The curing agent and the antistatic agent are similar to those of the magnetic layer 43 described above.

The average particle size of the nonmagnetic particles is preferably 10 nm or more and 150 nm or less, and more preferably 15 nm or more and 110 nm or less. The average particle size of the nonmagnetic particles is obtained similarly to the average particle size of the magnetic particles described above. The nonmagnetic particles may also contain nonmagnetic particles having two or more particle size distributions.

An upper limit value of an average thickness of the back layer 44 is preferably 0.60 μm or less. When the upper limit value of the average thickness of the back layer 44 is 0.60 μm or less, the thicknesses of the underlayer 42 and the base 41 can be kept thick even in a case where the average thickness of the magnetic tape MT is 5.30 μm or less, so that the traveling stability of the magnetic tape MT in the recording/reproducing device can be maintained. A lower limit value of the average thickness of the back layer 44 is not particularly limited, and is, for example, 0.20 μm or more.

The average thickness t_{b} of the back layer 44 is obtained as follows. First, an average thickness t_{T} of the magnetic tape MT is measured. The method of measuring the average thickness t_{T} is as described in the following “Average thickness of magnetic tape”. Subsequently, the magnetic tape MT accommodated in the cartridge 10 is unwound, and the magnetic tape MT is cut out to a length of 250 mm at a position of 30 m to 40 m in the longitudinal direction from one end on the outer peripheral side of the magnetic tape MT, thereby preparing a sample. Next, the back layer 44 of the sample is removed with a solvent such as methyl ethyl ketone (MEK) or dilute hydrochloric acid. Next, the thickness of the sample is measured at five positions using a laser hologauge (LGH-110C) manufactured by Mitutoyo Corporation, and these measured values are simply averaged (arithmetically averaged) to calculate an average t_{B} [μm]. Thereafter, the average thickness t_{b}[μm] of the back layer 44 is obtained by the following formula. Note that the five measurement positions described above are randomly selected from the sample so as to be different positions in the longitudinal direction of the magnetic tape MT.

$${t}_{b} [ μm ] = {t}_{T} [ μm ] - {t}_{B} [ μm ]$$

### (Lubricant Layer)

The lubricant layer 45 contains a lubricant. The lubricant is similar to the lubricant contained in the magnetic layer 43. The lubricant layer 45 may include a lubricant supplied from the magnetic layer 43 and the underlayer 42 to the magnetic surface.

### (Average Thickness of Magnetic Tape)

An upper limit value of the average thickness (average total thickness) t_{T} of the magnetic tape MT is preferably 5.30 μm or less, more preferably 5.10 μm or less, still more preferably 4.90 μm or less, and particularly preferably 4.70 μm or less. When the average thickness t_{T} of the magnetic tape MT is 5.30 μm or less, the recording capacity that can be recorded in one data cartridge can be increased as compared with a general magnetic tape. A lower limit value of the average thickness t_{T} of the magnetic tape MT is not particularly limited, and is, for example, 3.50 μm or more.

The average thickness t_{T} of the magnetic tape MT is obtained as follows. First, the magnetic tape MT accommodated in the cartridge 10 is unwound, and the magnetic tape MT is cut out to a length of 250 mm at a position of 30 m to 40 m in a longitudinal direction from one end on an outer peripheral side of the magnetic tape MT, thereby preparing a sample. Next, the thickness of the sample is measured at five positions using a laser hologauge (LGH-110C) manufactured by Mitutoyo Corporation as a measurement device, and these measured values are simply averaged (arithmetically averaged) to calculate the average thickness t_{T} [μm]. Note that the five measurement positions described above are randomly selected from the sample so as to be different positions in the longitudinal direction of the magnetic tape MT.

### (Coercive Force Hc2)

An upper limit value of the coercive force Hc2 of the magnetic layer 43 in the longitudinal direction of the magnetic tape MT is preferably 2000 Oe or less, more preferably 1900 Oe or less, and still more preferably 1800 Oe or less. When the coercive force Hc2 of the magnetic layer 43 in the longitudinal direction of the magnetic tape MT is 2000 Oe or less, sufficient electromagnetic conversion characteristics can be achieved even at a high recording density.

A lower limit value of the coercive force Hc2 of the magnetic layer 43 measured in the longitudinal direction of the magnetic tape MT is preferably 1000 Oe or more. When the coercive force Hc2 of the magnetic layer 43 measured in the longitudinal direction of the magnetic tape MT is 1000 Oe or more, it is possible to suppress demagnetization due to a leakage flux from the recording head.

The coercive force Hc2 described above is obtained as follows. First, the magnetic tape MT accommodated in the cartridge 10 is unwound, and six magnetic tapes MT are cut out at positions of 30 m to 40 in the longitudinal direction from one end on the outer peripheral side of the magnetic tape MT. At this time, marking is performed with an arbitrary ink having no magnetism so that the longitudinal direction (traveling direction) of the magnetic tape MT can be recognized. Next, three of the cut magnetic tapes MT are stacked with a double-sided tape such that the longitudinal directions of the three magnetic tapes MT are the same, and then punched with a punch of φ6.39 mm to prepare a measurement sample. Next, an M-H loop of the measurement sample (the entire magnetic tape MT) corresponding to the longitudinal direction (traveling direction) of the magnetic tape MT is measured using a vibrating sample magnetometer (VSM). Next, a coating film (the underlayer 42, the magnetic layer 43, the back layer 44, and the like) of the remaining three of the cut magnetic tapes MT is wiped off using acetone, ethanol, or the like, leaving only the base 41. Then, three sheets of the bases 41 obtained are stacked by use of a double-sided adhesive tape, and then punched out with a punch of φ6.39 mm to prepare a sample for background correction (hereinafter referred to simply as “correction sample”). Thereafter, the M-H loop of the correction sample (base 41) corresponding to the longitudinal direction of the base 41 (longitudinal direction of the magnetic tape MT) is measured using the VSM.

In the measurement of the M-H loop of the measurement sample (the entire magnetic tape MT) and the M-H loop of the correction sample (the base 41), a high-sensitivity vibrating sample magnetometer “VSM-P7-15 model” manufactured by Toei Industry Co., Ltd. is used. The measurement conditions are measurement mode: full loop, maximum magnetic field: 15 kOe, magnetic field step: 40 bit, time constant of locking amp: 0.3 sec, waiting time: 1 sec, and MH average number: 20.

After the M-H loop of the measurement sample (the entire magnetic tape MT) and the M-H loop of the correction sample (base 41) are obtained, the M-H loop of the correction sample (base 41) is subtracted from the M-H loop of the measurement sample (the entire magnetic tape MT), so that background correction is performed, and an M-H loop after the background correction is obtained. For calculation of the background correction, a measurement/analysis program attached to “model VSM-P7-15” is used. The coercive force Hc2 is obtained from the obtained M-H loop after the background correction. Note that for this calculation, the measurement and analysis program attached to “VSM-P7-15 model” is used. Note that it is assumed that every measurement of the M-H loop described above is performed at 25° C.±2° C. and 50% RH±5% RH. Furthermore, it is assumed that “demagnetizing field correction” when measuring the M-H loop in the longitudinal direction of the magnetic tape MT is not performed.

### (Square Ratio)

A square ratio S1 of the magnetic layer 43 in the vertical direction of the magnetic tape MT is preferably 62% or more, more preferably 65% or more, and still more preferably 68% or more, 72% or more, or 75% or more. When the square ratio S1 is 62% or more, the vertical orientation of the magnetic particles is sufficiently high, so that more excellent electromagnetic conversion characteristics can be obtained.

The square ratio S1 of the magnetic tape MT in the vertical direction is obtained as follows. First, a measurement sample is prepared in a similar manner to the method of measuring the coercive force Hc2 described above. Next, an M-H loop of the measurement sample (the entire magnetic tape MT) corresponding to the vertical direction of the magnetic tape MT (vertical direction of the magnetic tape MT) is measured using the VSM. Next, a correction sample is prepared in a similar manner to the method of measuring the coercive force Hc2 described above. Thereafter, the M-H loop of the correction sample (base 41) corresponding to the vertical direction of the base 41 (vertical direction of the magnetic tape MT) is measured using the VSM.

After the M-H loop of the measurement sample (the entire magnetic tape MT) and the M-H loop of the correction sample (base 41) are obtained, the M-H loop of the correction sample (base 41) is subtracted from the M-H loop of the measurement sample (the entire magnetic tape MT), so that background correction is performed, and an M-H loop after the background correction is obtained. For calculation of the background correction, a measurement/analysis program attached to “model VSM-P7-15” is used.

The square ratio S1(%) is calculated by substituting saturation magnetization Ms (emu) and residual magnetization Mr (emu) of the obtained M-H loop after the background correction into the following equation. Note that it is assumed that every measurement of the M-H loop described above is performed at 25° C.±2° C. and 50% RH±5% RH. Furthermore, it is assumed that “demagnetizing field correction” when measuring the M-H loop in the vertical direction of the magnetic tape MT is not performed. Note that for this calculation, the measurement and analysis program attached to “VSM-P7-15 model” is used.

$$Square ratio S 1 ( \% ) = ( Mr / Ms ) \times 100$$

A square ratio S2 of the magnetic layer 43 in the longitudinal direction (traveling direction) of the magnetic tape MT is preferably 35% or less, more preferably 30% or less, and still more preferably 25% or less, 20% or less, or 15% or less. When the square ratio S2 is 35% or less, the vertical orientation of the magnetic particles is sufficiently high, so that more excellent electromagnetic conversion characteristics can be obtained. Note that one of the square ratio S1 of the magnetic layer 43 in the vertical direction of the magnetic tape MT and the square ratio S2 of the magnetic layer 43 in the longitudinal direction (traveling direction) of the magnetic tape MT may be within the above preferable range, and the other may be out of the above preferable range. Alternatively, both the square ratio S1 of the magnetic layer 43 in the vertical direction of the magnetic tape MT and the square ratio S2 of the magnetic layer 43 in the longitudinal direction (traveling direction) of the magnetic tape MT may be within the above preferable ranges.

The square ratio S2 of the magnetic tape MT in the longitudinal direction is obtained in a manner similar to that of the square ratio S1 except that the M-H loop is measured in the longitudinal direction (traveling direction) of the magnetic tape MT and the base 41.

### (Ratio Hc2/Hc1)

A ratio Hc2/Hc1 of the coercive force Hc1 of the magnetic layer 43 in the vertical direction of the magnetic tape MT to the coercive force Hc2 of the magnetic layer 43 in the longitudinal direction of the magnetic tape MT preferably satisfies a relationship of Hc2/Hc1≤0.8, more preferably Hc2/Hc1≤0.75, and still more preferably Hc2/Hc1≤0.7, Hc2/Hc1≤0.65, or Hc2/Hc1≤0.6. When the coercive forces Hc1 and Hc2 satisfy the relationship of Hc2/Hc1≤0.8, a degree of vertical orientation of the magnetic particles can be increased. Therefore, it is possible to reduce a magnetization transition width and to obtain a high-output signal at the time of signal reproduction, so that more excellent electromagnetic conversion characteristics can be obtained. Note that when Hc2 is small as described above, the magnetization reacts with a high degree of sensitivity by a vertical magnetic field from the recording head, so that a good recording pattern may be formed.

In a case where the ratio Hc2/Hc1 is Hc2/Hc1≤0.8, it is particularly effective that the average thickness t₁ of the magnetic layer 43 is 90 nm or less. When the average thickness t₁ of the magnetic layer 43 exceeds 90 nm, in a case where a ring-type head is used as the recording head, a lower region (a region on the underlayer 42 side) of the magnetic layer 43 would be magnetized in the longitudinal direction of the magnetic tape MT, and it may become impossible to uniformly magnetize the magnetic layer 43 in the thickness direction. Therefore, it may be impossible to obtain more excellent electromagnetic conversion characteristics even when the ratio Hc2/Hc1 is set to be Hc2/Hc1≤0.8 (namely, even when the degree of vertical orientation of the magnetic particles is enhanced).

A lower limit value of Hc2/Hc1 is not particularly limited, and is, for example, 0.5 Hc2/Hc1. Note that Hc2/Hc1 represents the degree of vertical orientation of the magnetic particles, and the smaller Hc2/Hc1, the higher the degree of vertical orientation of the magnetic particles.

The method of calculating the coercive force Hc2 of the magnetic layer 43 in the longitudinal direction of the magnetic tape MT is as described above. The coercive force Hc1 of the magnetic layer 43 in the vertical direction of the magnetic tape MT is obtained similarly to the coercive force Hc2 of the magnetic layer 43 in the longitudinal direction of the magnetic tape MT except that the M-H loop is measured in the vertical direction (thickness direction) of the magnetic tape MT and the base 41.

### (Activation Volume V_{act})

An activation volume V_{act} is preferably 8000 nm³ or less, more preferably 6000 nm³ or less, and still more preferably 5000 nm³ or less, 4000 nm³ or less, or 3000 nm³ or less. When the activation volume V_{act} is 8000 nm³ or less, a dispersion state of the magnetic particles becomes excellent, so that a bit inversion region may be made steep, and it is possible to suppress the deterioration in magnetic signal recorded in an adjacent track by a leakage magnetic field from the recording head. Therefore, there is a possibility that more excellent electromagnetic conversion characteristics cannot be obtained.

The activation volume V_{act} described above is obtained by following formula derived by Street and Woolley.

$${V}_{act} ( {nm}^{3} ) = {k}_{B} \times T \times {X}_{irr} / ( {μ}_{0} \times Ms \times S )$$

(where k_{B}: Boltzmann's constant (1.38×10⁻²³ J/K), T: temperature (K), Xᵢᵣᵣ: irreversible magnetic susceptibility, μ₀: vacuum magnetic permeability, S: magnetic viscosity coefficient, and Ms: saturation magnetization (emu/cm³))

The irreversible magnetic susceptibility Xᵢᵣᵣ, the saturation magnetization Ms, and the magnetic viscosity coefficient S to be substituted in the above formula are obtained as follows by using the VSM. Note that a measurement direction by the VSM is assumed to be the vertical direction (thickness direction) of the magnetic tape MT. Furthermore, it is assumed that the measurement by the VSM is performed on the measurement sample cut out from the elongated magnetic tape MT at 25° C.±2° C. and 50% RH±5% RH. Furthermore, it is assumed that “demagnetizing field correction” when measuring the M-H loop in the vertical direction (thickness direction) of the magnetic tape MT is not performed.

### (Irreversible Magnetic Susceptibility Xᵢᵣᵣ)

The irreversible magnetic susceptibility Xᵢᵣᵣ is defined as an inclination in the vicinity of a residual coercive force Hr in an inclination of a residual magnetization curve (DCD curve). First, a magnetic field of −1193 kA/m (15 kOe) is applied to a whole of the magnetic tape MT, and the magnetic field is returned to zero to obtain a residual magnetization state. Thereafter, a magnetic field of about 15.9 kA/m (200 Oe) is applied in the opposite direction to return to zero again, and a residual magnetization amount is measured. Thereafter, similarly, measurement to apply a magnetic field larger than the above-described applied magnetic field by 15.9 kA/m to return to zero is repeatedly performed, the residual magnetization amount is plotted to the applied magnetic field, and the DCD curve is measured. From the obtained DCD curve, a point at which the magnetization amount is zero is made the residual coercive force Hr, the DCD curve is further differentiated, and the inclination of the DCD curve at each magnetic field is obtained. In the inclination of this DCD curve, the inclination in the vicinity of the residual coercive force Hr is Xᵢᵣᵣ.

### (Saturation Magnetization Ms)

First, an M-H loop after background correction is obtained in a manner similar to the method of measuring the square ratio S1 described above. Next, Ms (emu/cm³) is calculated from a value of saturation magnetization Ms (emu) of the obtained M-H loop and a volume (cm³) of the magnetic layer 43 in the measurement sample. Note that the volume of the magnetic layer 43 is obtained by multiplying an area of the measurement sample by the average thickness t₁ of the magnetic layer 43. The method of calculating the average thickness t₁ of the magnetic layer 43 required for calculating the volume of the magnetic layer 43 is as described above.

### (Magnetic Viscosity Coefficient S)

First, a magnetic field of −1193 kA/m (15 kOe) is applied to a whole of the magnetic tape MT (measurement sample), and the magnetic field is returned to zero to obtain the residual magnetization state. Thereafter, a magnetic field equivalent to the value of the residual coercive force Hr obtained from the DCD curve is applied in the opposite direction. The magnetization amount is continuously measured at regular time intervals for 1000 seconds in a state in which the magnetic field is applied. A magnetic viscosity coefficient S is calculated by checking a relationship between time t and the magnetization amount M(t) against the following formula obtained in this manner.

$$M ( t ) = M 0 + S \times ln ( t )$$

(where M(t): magnetization amount at time t, M0: initial magnetization amount, S: magnetic viscosity coefficient, and ln(t): natural logarithm of time)

### (Surface Roughness R_{b} of Back Surface)

A surface roughness R_{b} of the back surface (surface roughness of the back layer 44) preferably satisfies Rb≤6.0 [nm]. When the surface roughness R_{b} of the back surface is in the above range, more excellent electromagnetic conversion characteristics can be obtained.

The surface roughness R_{b} of the back surface is obtained as follows. First, the magnetic tape MT accommodated in the cartridge 10 is unwound, and the magnetic tape MT is cut out to a length of 100 mm at a position of 30 m to 40 m in the longitudinal direction from one end on the outer peripheral side of the magnetic tape MT, thereby preparing a sample. Next, the sample is placed on a slide glass so that a surface to be measured (surface on the magnetic layer 43 side) of the sample is oriented upwardly, and an end portion of the sample is fixed with a mending tape. The surface shape is measured using VertScan (20× objective lens) as a measurement device, and the surface roughness R_{b} of the back surface is obtained from the following formula on the basis of the standard of ISO 25178.

The measurement conditions are as follows.
Device: Non-contact roughness meter using optical interference
(non-contact surface/layer cross-section shape measurement system VertScan R5500GL-M100-AC manufactured by Ryoka Systems Inc.)
Objective lens: 20 times
Measurement region: 640×480 pixels (field of view: about 237 μm×178 μm field of view)
Measurement mode: Phase
Wavelength filter: 520 nm
CCD: ⅓ inch
Noise removal filter: Smoothing 3×3
Surface correction: Correction on quadratic polynomial approximated surface
Measurement software: VS-Measure Version 5.5.2
Analysis software: VS-viewer Version 5.5.5

$${S}_{a} = \frac{1}{A} \int {\int }_{A} \vert Z ( x , y ) \vert dxdy \qquad [ Mathematical formula 2 ]$$

After measuring the surface roughness at five points in the longitudinal direction of the magnetic tape MT as described above, an average value of arithmetic average roughnesses Sₐ (nm) automatically calculated from the surface profile obtained at each position is taken as the surface roughness R_{b} (nm) of the back surface.

### (Young's Modulus of Magnetic Tape in Longitudinal Direction)

An upper limit value of the Young's modulus of the magnetic tape MT in the longitudinal direction is preferably 9.0 GPa or less, more preferably 8.0 GPa or less, still more preferably 7.5 GPa or less, and particularly preferably 7.1 GPa or less. When the Young's modulus of the magnetic tape MT in the longitudinal direction is 9.0 GPa or less, the stretchability of the magnetic tape MT due to the external force further increases, so that adjustment of the width of the magnetic tape MT by tension adjustment is further facilitated. Therefore, off-track can be more suitably suppressed, and data recorded on the magnetic tape MT can be more accurately reproduced. A lower limit value of the Young's modulus of the magnetic tape MT in the longitudinal direction is preferably 3.0 GPa or more, and more preferably 4.0 GPa or more. When the lower limit value of the Young's modulus of the magnetic tape MT in the longitudinal direction is 3.0 GPa or more, a decrease in traveling stability can be suppressed.

The Young's modulus of the magnetic tape MT in the longitudinal direction is a value indicating the difficulty of expansion and contraction of the magnetic tape MT in the longitudinal direction due to an external force. The larger this value, the more difficult the magnetic tape MT is expanded and contracted in the longitudinal direction due to the external force. The smaller this value, the easier the magnetic tape MT is expanded and contracted in the longitudinal direction due to the external force.

Note that the Young's modulus of the magnetic tape MT in the longitudinal direction is a value relating to the magnetic tape MT in the longitudinal direction, and is correlated with the difficulty of expansion and contraction of the magnetic tape MT in the width direction. That is, the larger this value, the more difficult the magnetic tape MT is expanded and contracted in the width direction due to an external force. The smaller this value, the easier the magnetic tape MT is expanded and contracted in the width direction due to the external force. Therefore, from the viewpoint of tension adjustment, it is advantageous that the Young's modulus of the magnetic tape MT in the longitudinal direction is small as described above and is 9.0 GPa or less.

For measurement of the Young's modulus, a tensile tester (manufactured by Shimadzu Corporation, AG-100D) is used. In a case where the Young's modulus in the tape longitudinal direction is desired to be measured, the magnetic tape MT accommodated in the cartridge 10 is unwound, and the magnetic tape MT is cut out to a length of 180 mm at a position of 30 m to 40 m in the longitudinal direction from one end on the outer peripheral side of the magnetic tape MT, thereby preparing a sample. A jig capable of fixing the tape width (½ inch) is attached to the tensile tester described above to fix the top and bottom of the tape width. The distance (length of the tape between chucks) is set to 100 mm. After chucking the data sample, stress is gradually applied in the direction of pulling the sample. The tensile speed is 0.1 mm/min. The Young's modulus is calculated using the following formula on the basis of the change in stress and the amount of elongation at this time.

$$E ( N / {m}^{2} ) = ( ( Δ N / S ) / ( Δ x / L ) ) \times {10}^{6}$$

ΔN: Change in stress (N)
S: Cross-sectional area of test piece (mm²)
Δx: Elongation amount (mm)
L: Distance between gripping jigs (mm)
A cross-sectional area S of the measurement sample 10S described above is a cross-sectional area before tensile operation, and is obtained by a product of the width (½ inch) of the measurement sample 10S and the thickness of the measurement sample 10S. For a range of tensile stress at the time of measurement, the range of the tensile stress in a linear region is set according to the thickness of the magnetic tape MT or the like. In this case, the range of the stress is 0.2 N to 0.7 N, and the change in stress (ΔN) and the elongation amount (Δx) at this time are used for calculation. Note that the measurement of the Young's modulus described above is performed at 25° C.±2° C. and 50% RH±5% RH.

### (Young's Modulus of Base in Longitudinal Direction)

The Young's modulus of the base 41 in the longitudinal direction is preferably 7.8 GPa or less, more preferably 7.0 GPa or less, still more preferably 6.6 GPa or less, and particularly preferably 6.4 GPa or less. When the Young's modulus of the base 41 in the longitudinal direction is 7.8 GPa or less, the stretchability of the magnetic tape MT due to the external force further increases, so that adjustment of the width of the magnetic tape MT by tension adjustment is further facilitated. Therefore, off-track can be more suitably suppressed, and data recorded on the magnetic tape MT can be more accurately reproduced. The lower limit value of the Young's modulus of the base 41 in the longitudinal direction is preferably 2.5 GPa or more, and more preferably 3.0 GPa or more. When the lower limit value of the Young's modulus of the base 41 in the longitudinal direction is 2.5 GPa or more, the decrease in traveling stability can be suppressed.

The Young's modulus of the base 41 described above in the longitudinal direction is determined as follows. First, the magnetic tape MT accommodated in the cartridge 10 is unwound, and the magnetic tape MT is cut out to a length of 180 mm at a position of 30 m to 40 m in the longitudinal direction from one end on the outer peripheral side of the magnetic tape MT. Subsequently, the underlayer 42, the magnetic layer 43, and the back layer 44 are removed from the cut magnetic tape MT to obtain the base 41. Using this base 41, the Young's modulus of the base 41 in the longitudinal direction is obtained in a similar procedure to the above-mentioned Young's modulus of the magnetic tape MT described above in the longitudinal direction.

The thickness of the base 41 is half or more of the thickness of the entire magnetic tape MT. Therefore, the Young's modulus of the base 41 in the longitudinal direction is correlated with the difficulty of expansion and contraction of the magnetic tape MT due to an external force. The larger this value, the more difficult the magnetic tape MT is expanded and contracted in the width direction due to the external force. The smaller this value, the easier the magnetic tape MT is expanded and contracted in the width direction due to the external force.

Note that the Young's modulus of the base 41 in the longitudinal direction is a value relating to the magnetic tape MT in the longitudinal direction, and is correlated with the difficulty of expansion and contraction of the magnetic tape MT in the width direction. That is, the larger this value, the more difficult the magnetic tape MT is expanded and contracted in the width direction due to an external force. The smaller this value, the easier the magnetic tape MT is expanded and contracted in the width direction due to the external force. Therefore, from the viewpoint of tension adjustment, it is advantageous that the Young's modulus of the base 41 in the longitudinal direction is small as described above and is 7.8 GPa or less.

### (Average Electron Count Rate)

Conventionally, the amount of a lubricant in a magnetic tape has been generally obtained by examining the addition amount in a manufacturing process, the extraction amount of a lubricant extracted from the magnetic tape using a solvent, or the like. However, with these methods, it has been difficult to obtain information on the amount of the lubricant actually present at a contact portion between the head and the magnetic tape. Furthermore, it is also difficult to obtain information on the amount of carbon actually present on the surface of the magnetic layer.

On the other hand, in the present embodiment, information on the amount of lubricant actually present at the contact portion between the head unit 56 and the magnetic tape MT can be obtained by obtaining the difference between the average electron count rates before and after cleaning (before and after removing the lubricant). Furthermore, information on the amount of carbon actually present on the magnetic surface can be obtained by obtaining the average electron count rate of the magnetic surface after cleaning (after removing the lubricant).

For example, in a case where the magnetic particles are ferrite particles, photoelectrons emitted from the magnetic surface due to the photoelectric effect are emitted only from carbon contained in the magnetic surface, and the other materials absorb photoelectrons emitted from carbon. Therefore, by obtaining the electron count rate of the magnetic surface after cleaning (after removing the lubricant), the effective amount of carbon present on the magnetic surface can be estimated. Furthermore, by obtaining the difference in the average electron count rate before and after cleaning (before and after removing the lubricant), the amount (relative value) of the lubricant existing on the magnetic surface can be estimated.

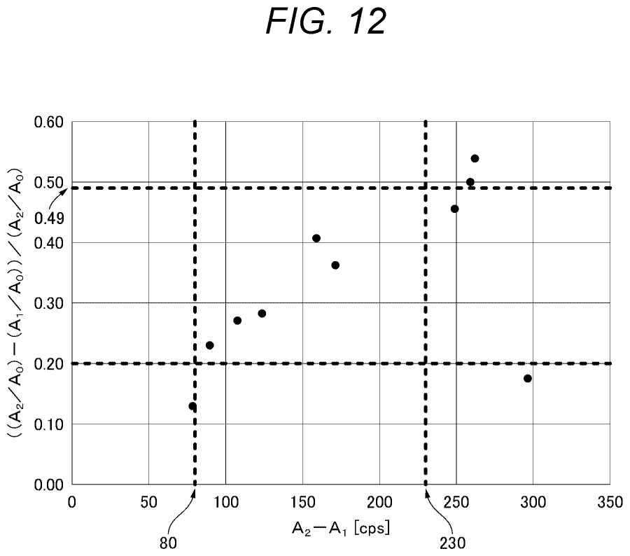

The average electron count rate (hereinafter, the average electron count rate of the standard sample is referred to as “average electron count rate of the standard sample”) of the surface of the standard sample measured by atmospheric photoelectron yield spectroscopy is defined as A₀, the average electron count rate (hereinafter, the average electron count rate of the magnetic tape MT before cleaning is referred to as “average electron count rate of the magnetic tape MT before cleaning”) of the magnetic surface measured by the atmospheric photoelectron yield spectroscopy before cleaning the magnetic tape MT is defined as A₁, and the average electron count rate (hereinafter, the average electron count rate of the magnetic tape MT after cleaning is referred to as “average electron count rate of the magnetic tape MT after cleaning”) of the magnetic surface measured by the atmospheric photoelectron yield spectroscopy after cleaning the magnetic tape MT is defined as A₂. As illustrated in FIG. 12, A₂−A₁ is an x-axis coordinate, and ((A₂/A₀)−(A₁/A₀))/(A₂/A₀) is a y-axis coordinate.

x(=A₂−A₁) is preferably 80 [cps]≤x≤230 [cps], more preferably 80 [cps]≤x≤200 [cps], and still more preferably 90 [cps]≤x≤171 [cps]. y=(=((A₂/A₀)−(A₁/A₀))/(A₂/A₀)) is 0.20≤y≤0.49, preferably 0.20≤y≤0.45, and more preferably 0.23≤y≤0.41.

When Y>0.49, the amount of lubricant on the magnetic surface is large and the amount of photoelectrons from the magnetic surface is small. Therefore, since the lubricant layer 45 is too thick and the amount of carbon particles on the magnetic surface is not sufficient, the magnetic tape MT is likely to adhere to the head, leading to an increase in dynamic friction of the magnetic tape MT and a decrease in traveling stability.

When Y<0.20, the thickness of the lubricant layer 45 is thin and insufficient, and many carbon particles are present on the magnetic surface, so that carbon particles are likely to be scraped, and adhere onto the head, leading to an increase in dynamic friction. Furthermore, in a case where carbon particles are excessively present on the magnetic surface, electromagnetic conversion characteristics are also deteriorated.

When X>230, since the amount of lubricant on the magnetic surface is excessive, the spacing is increased, and good electromagnetic conversion characteristics cannot be obtained.

When X<80, since the amount of lubricant on the magnetic surface is insufficient, head adhesion occurs, which deteriorates electromagnetic conversion characteristics.

$$x ( = {A}_{2} - {A}_{1} ) and y ( = ( ( {A}_{2} / {A}_{0} ) - ( {A}_{1} / {A}_{0} ) ) / ( {A}_{2} / {A}_{0} ) )$$

are obtained as follows.

The average electron count rate A₀ of the standard sample is obtained as follows. First, a standard sample (model 9161 4361 20) for an atmospheric photoelectron yield spectrometer (Riken Keiki Co., Ltd., AC-2) is prepared. The standard sample includes gold (Au). Next, the standard sample is bonded to a slide glass with a Kapton (registered trademark) double-sided tape, then set on a sample stage of the atmospheric photoelectron yield spectrometer, and an electron count rate per 1 second is measured 10 times with measurement energy of 6.2 eV (λ=200 nm) and a prescribed set light amount (irradiation light amount). The measurement is performed under an environment of 25° C.±2° C. and 50% RH±5% RH. Next, the average electron count rate of the standard sample is calculated by simply averaging (arithmetically averaging) the 10 measured values.

The prescribed set light amount is set within a range of 500 nW or less so that the electron count rate falls within a range of 2000 cps or less. The reason why the set light amount is set within the range of 500 nW or less is that when the set light amount exceeds 500 nW, there is a possibility that the measured electron count rate becomes unstable. The reason why the set light amount is set so that the count number is 2000 cps or less is that when the electron count rate exceeds 2000 cps, the measurement accuracy of the atmospheric photoelectron yield spectrometer is deteriorated. In the measurement of the standard sample of Examples described later, the set light amount was set to 50 nmW, and the average electron count rate A₀ of the standard sample at the set light amount was 709 cps (see Table 1).

The average electron count rate A₁ of the magnetic tape MT before cleaning is obtained as follows. First, the magnetic tape MT housed in the cartridge 10 is unwound, and the magnetic tape MT is cut out from a position of 30 m to 40 m in the longitudinal direction from one end on the outer peripheral side of the magnetic tape MT, thereby preparing a measurement sample. At this time, the measurement sample is cut into a rectangular shape (rectangular shape larger than 4 mm×4 mm) larger than the spot diameter of the optical system of the spectroscopic device. Next, the measurement sample is bonded to a slide glass with a Kapton (registered trademark) double-sided tape and set on a sample stage of the atmospheric photoelectron yield spectrometer. The subsequent steps are performed by a similar procedure to the method of calculating the average electron count rate A₀ of the standard sample, whereby the average electron count rate A₁ of the magnetic tape MT before cleaning is obtained. In the measurement of the average electron count rate A₁ of Examples described later, the set light amount of the sample before cleaning was set to 500 nmW (see Table 1).

The average electron count rate A₂ of the magnetic tape MT after cleaning is obtained as follows. First, a measurement sample is prepared by a similar procedure to the method of measuring the average electron count rate A₁. Next, the measurement sample is immersed in hexane for 24 hours to remove the lubricant, and then naturally dried. A measurement sample after drying (that is, after removing the lubricant) is bonded to a slide glass with a Kapton (registered trademark) double-sided tape, and set on a sample stage of the atmospheric photoelectron yield spectrometer. The subsequent steps are performed by the similar procedure to the method of calculating the average electron count rate A₀ of the standard sample, whereby the average electron count rate A₂ of the magnetic tape MT after cleaning is obtained. In the measurement of the average electron count rate A₂ in Examples described later, the set light amount was set to 500 nmW (see Table 1).

Using the average electron count rate A₁ of the magnetic tape MT before cleaning and the average electron count rate A₂ of the magnetic tape MT after cleaning obtained as described above, x(=A₂−A₁) is obtained. Furthermore, y(=((A₂/A₀)−(A₁/A₀))/(A₂/A₀)) is obtained using the average electron count rate A₀ of the standard sample obtained as described above, the average electron count rate A₁ of the magnetic tape MT before cleaning, and the average electron count rate A₂ of the magnetic tape MT after cleaning.

Even if the standard sample is washed with hexane, the electron count rate of the standard sample does not change. Therefore, as described above, both the average electron count rate A₁ of the magnetic tape MT before cleaning and the average electron count rate A₂ of the magnetic tape MT after cleaning are normalized ((A₂/A₀), (A₁/A₀)) using the average electron count rate A₀ of the standard sample measured in a state without cleaning with hexane.

### (Dynamic Friction Coefficient Ratio μ(250)/μ(5))

In a case where a dynamic friction coefficient between the magnetic surface and the magnetic head when a tension applied to the magnetic tape MT is 0.6 N is μ, a dynamic friction coefficient ratio (μ(250)/μ(5)) between a dynamic friction coefficient μ(5) in fifth travel and a dynamic friction coefficient μ(250) in 250th travel is preferably 1.00 or more and 1.25 or less, more preferably 1.00 or more and 1.15 or less, and still more preferably 1.00 or more and 1.12 or less, 1.00 or more and 1.10 or less, 1.00 or more and 1.05 or less, or 1.00 or more and 1.02 or less. When the dynamic friction coefficient ratio (μ(250)/μ(5)) is 1.00 or more and 1.25 or less, a change in the dynamic friction coefficient after 250 times of traveling can be reduced, so that deterioration in traveling stability of the magnetic tape MT can be suppressed even after 250 times of traveling.

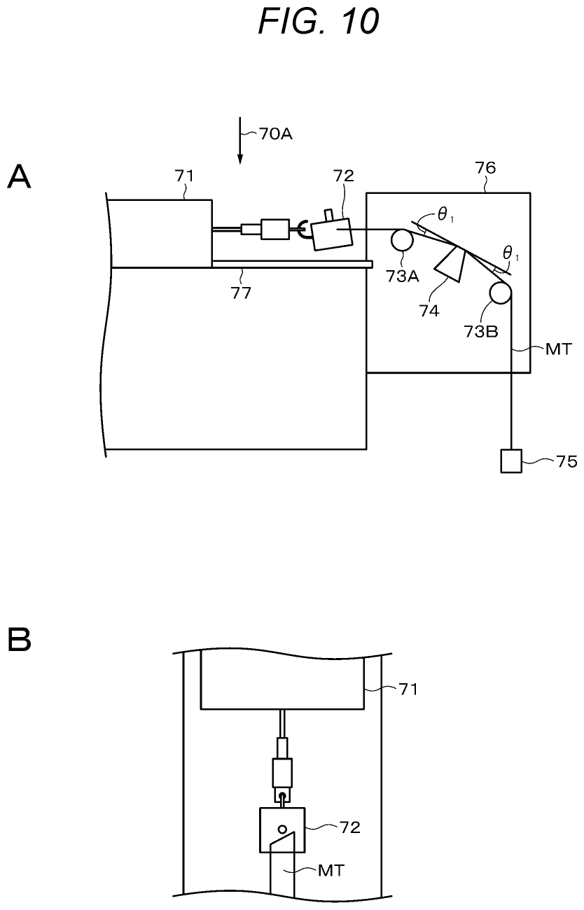

The dynamic friction coefficient μ(5) and the dynamic friction coefficient μ(250) for calculating the dynamic friction coefficient ratio (μ(250)/μ(5)) are obtained as follows. First, the magnetic tape MT accommodated in the cartridge 10 is unwound, and the magnetic tape MT is cut out to a length of 250 mm at a position of 30 m to 40 m in the longitudinal direction from one end on the outer peripheral side of the magnetic tape MT. Next, as illustrated in FIG. 10A, the magnetic tape MT having a ½ inch width is placed on two cylindrical guide rolls 73A and 73B having a 1 inch diameter, which are disposed in parallel to be spaced apart from each other, such that the magnetic surface is in contact with the guide rolls. The two guide rolls 73A and 73B are fixed to a hard plate-shaped member 76, whereby a positional relationship therebetween is fixed.

Next, the magnetic surface of the magnetic tape MT is brought into contact with a head block (for recording and reproducing) 74 so that a holding angle 61(°)=20° is established. As the head block 74, a recording/reproducing head of an LTO4 drive manufactured by Hewlett-Packard Enterprise (HPE) is used. The head block 74 is disposed substantially at the center of the guide rolls 73A and 73B. The head block 74 is movably attached to the plate-shaped member 76 so that the holding angle θ₁ can be changed, but when the holding angle θ₁(°) becomes 20°, the position thereof is fixed with respect to the plate-shaped member 76, whereby a positional relationship between the guide rolls 73A and 73B and the head block 74 is also fixed.

One end of the magnetic tape MT is connected to a movable strain gauge 71 via a jig 72. The magnetic tape MT is fixed to the jig 72 as illustrated in FIG. 10B. A weight 75 is connected to the other end of the magnetic tape MT. A tension (T₀ [N]) of 0.6 N is applied by the weight 75 in the longitudinal direction of the magnetic tape MT. The movable strain gauge 71 is fixed on a table 77. A positional relationship between the table 77 and the plate-shaped member 76 is also fixed, whereby a positional relationship between the guide rolls 73A and 73B, the head block 74, and the movable strain gauge 71 is fixed.

The magnetic tape MT is reciprocated as follows.

(Forward) The magnetic tape MT is slid by 60 mm so that the magnetic tape MT approaches the movable strain gauge 71 at a moving speed of 10 mm/s with respect to the head block 74.

(Return path) The magnetic tape MT is slid by 60 mm so that the magnetic tape MT is separated from the movable strain gauge 71 at a moving speed of 10 mm/s with respect to the head block 74.

This reciprocating operation is repeated 250 times. Among the 250 reciprocating operations, an output value (voltage) of the movable strain gauge 71 is acquired 13 times from the start of sliding to the end of sliding in the 60 mm slide in the fifth forward path, and is converted into T [N] on the basis of a linear relationship (described later) between an output value acquired in advance and a load. Tₐᵥₑ [N] is obtained by simply averaging 11 excluding the first and last 2 in total. Note that the measurement environment is maintained at 25° C.±2° C. and 50% RH±5% RH.

Thereafter, the dynamic friction coefficient μ(5) is obtained by the following formula.

$$μ ( 5 ) = \frac{1}{( {θ}_{1} [ ° ] \times ( π / 180 )} \times ln ( \frac{{T}_{ave} [ N ]}{{T}_{0} [ N ]} ) \qquad [ Mathematical formula 3 ]$$

The linear relationship is obtained as follows. That is, an output value (voltage) of the movable strain gauge 71 is obtained for each of a case where a load of 0.4 N is applied to the movable strain gauge 71 and a case where a load of 1.5 N is applied to the movable strain gauge. A linear relationship between the output value and the load is obtained from the two obtained output values and the two loads. Using the linear relationship, the output value (voltage) from the movable strain gauge 71 during sliding is converted into T [N] as described above.

Moreover, the dynamic friction coefficient μ(250) is obtained in a similar manner to the dynamic friction coefficient μ(5) except that the 250th forward path is measured.

The dynamic friction coefficient ratio μ(250)/μ(5) is calculated from the dynamic friction coefficient μ(5) and the dynamic friction coefficient μ(250) measured as described above.

### (Arithmetic Average Roughness Ra of Surface of Magnetic Layer)

An arithmetic average roughness Ra of the magnetic surface is preferably 2.0 nm or less, more preferably 1.9 nm or less, and still more preferably 1.6 nm or less, 1.5 nm or less, or 1.3 nm or less. When the arithmetic average roughness Ra is 2.0 nm or less, a decrease in output due to spacing loss can be suppressed, so that excellent electromagnetic conversion characteristics can be obtained. A lower limit value of the arithmetic average roughness Ra of the magnetic surface is preferably 1.0 nm or more, and more preferably 1.2 nm or more. When the lower limit value of the arithmetic average roughness Ra of the magnetic surface is 1.0 nm or more, it is possible to suppress a decrease in traveling performance due to an increase in friction.

The arithmetic average roughness Ra is obtained as follows. First, the magnetic tape MT accommodated in the cartridge 10 is unwound, and the magnetic tape MT is cut out to a length of 250 mm at a position of 30 m to 40 m in the longitudinal direction from one end on the outer peripheral side of the magnetic tape MT, thereby preparing a sample. Next, the magnetic surface of the sample is observed with an atomic force microscope (AFM) to obtain an AFM image of 40 μm×40 μm. As the AFM, Nano Scope IIIa D3100 manufactured by Digital Instruments is used, and as the cantilever, a cantilever including silicon single crystal is used (Note 1). The measurement is performed by tuning at 200 to 400 Hz as a tapping frequency. Next, the AFM image is divided into 512×512 (=262,144) measurement points, a height Z(i) (i: measurement point number, i=1 to 262,144) is measured at each measurement point, and heights Z(i) measured at the measurement points are simply averaged (arithmetically averaged) to obtain an average height (average plane) Zave(=(Z(1)+Z(2)+ . . . +Z(262,144))/262,144). Subsequently, a deviation Z″(i)(=Z(i)−Zave) from an average center line at each measurement point is obtained, and the arithmetic average roughness Ra [nm](=(Z″(1)+Z″(2)+ . . . +Z″(262,144))/262,144) is calculated. At this time, as the image processing, data obtained by performing filtering processing by Flatten order 2 and planefit order 3 XY is used.
(Note 1) Manufactured by Nano World, SPM probe NCH normal type PointProbe L (cantilever length)=125 μm

### [4 Manufacturing Method of Magnetic Tape]

Next, an example of a manufacturing method of the magnetic tape MT having the configuration described above will be described.

### (Preparation Step of Coating Material)

First, nonmagnetic particles, a binder, and the like are kneaded and dispersed in a solvent to prepare an underlayer forming coating material. Next, magnetic particles, a binder, carbon particles and the like are kneaded and dispersed in a solvent to prepare a magnetic layer forming coating material. For the preparation of the magnetic layer forming coating material and the underlayer forming coating material, for example, the following solvents, dispersing device, and kneading device can be used.

Examples of the solvent used for the coating material preparation described above include, for example, ketone solvents such as acetone, methyl ethyl ketone, methyl isobutyl ketone, and cyclohexanone, alcohol solvents such as methanol, ethanol, and propanol, ester solvents such as methyl acetate, ethyl acetate, butyl acetate, propyl acetate, ethyl lactate, and ethylene glycol acetate, ether solvents such as diethylene glycol dimethyl ether, 2-ethoxyethanol, tetrahydrofuran, and dioxane, aromatic hydrocarbon solvents such as benzene, toluene, and xylene, halogenated hydrocarbon solvents such as methylene chloride, ethylene chloride, carbon tetrachloride, chloroform, and chlorobenzene. They may be used alone, or they may be mixed appropriately.

As a kneading device used for the coating material preparation described above, for example, kneading devices such as a continuous two-axis kneader, a continuous two-axis kneader capable of diluting in multiple stages, a kneader, a pressure kneader, and a roll kneader may be used, but this is not especially limited to such devices. Furthermore, as a dispersing device used for the coating material preparation described above, for example, dispersing devices such as a roll mill, a ball mill, a horizontal sand mill, a vertical sand mill, a spike mill, a pin mill, a tower mill, a pearl mill (for example, “DCP mill” manufactured by Eirich Co., Ltd. and the like), a homogenizer, and an acoustic wave dispersing device may be used, but it is not especially limited to these devices.

### (Application Step)

Next, the underlayer forming coating material is applied to one principal surface of the base 41 and dried to form the underlayer 42. Subsequently, the magnetic layer forming coating material is applied onto the underlayer 42 and dried to form the magnetic layer 43 on the underlayer 42. Note that, at the time of drying, magnetic particles may be magnetically oriented in the thickness direction of the base 41 by, for example, a solenoid coil. After the magnetic layer 43 is formed, the back layer 44 is formed on the other principal surface of the base 41. Therefore, the magnetic tape MT is obtained. Note that the order of formation of the underlayer 42, the magnetic layer 43, and the back layer 44 is not limited to the above example. For example, after the back layer 44 is formed on the other principal surface of the base 41, the underlayer 42 and the magnetic layer 43 may be sequentially formed on one principal surface of the base 41.

The square ratios S1 and S2 are, for example, set to desired values by adjusting strength of the magnetic field applied to the coating film of the magnetic layer forming coating material, concentration of a solid content in the magnetic layer forming coating material, and a drying condition of the coating film of the magnetic layer forming coating material (drying temperature and drying time). The strength of the magnetic field applied to the coating film is preferably twice or more and three times or less of the coercive force of the magnetic particles. In order to further increase the square ratio S1 (that is, to further decrease the square ratio S2), it is preferable to improve the dispersion state of the magnetic particles in the magnetic layer forming coating material. Furthermore, in order to further increase the square ratio S1, it is also effective to magnetize the magnetic particles at a stage before the magnetic layer forming coating material enters an orienting device for performing the magnetic field orientation of the magnetic particles. Note that, the methods of adjusting the square ratios S1 and S2 may be used alone, or two or more methods may be used in combination.

### (Curing Step)

Next, after the magnetic tape MT is wound into a roll shape, heat treatment is performed in this state to the magnetic tape MT to cure the underlayer 42 and the magnetic layer 43.

### (Calendering Step)

Next, the obtained magnetic tape MT is subjected to calendering treatment to smooth the magnetic surface.

### (Cutting Step)

Next, the magnetic tape MT is cut into a predetermined width (for example, ½ inch width). Thus, the magnetic tape MT is obtained.

### (Servo Write Step)

Next, after demagnetization of the magnetic tape MT is performed as necessary, a servo pattern may be written on the magnetic tape MT.

(Adjustment Conditions of Average Electron Count Rates A₁ and A₂)

The values of the average electron count rates A₁ and A₂ (that is, x(=A₂−A₁) and y(=((A₂/A₀)−(A₁/A₀))/(A₂/A₀))) can be set to desired values, for example, by adjusting at least one condition selected from the group consisting of the following conditions (a) to (d).
(a) Addition amount of carbon in coating material adjustment step
(b) Drying conditions of the magnetic layer forming coating material in the application step (for example, at least one condition selected from the group consisting of a drying temperature and a drying time)
(c) Conditions of heat treatment in curing step (for example, at least one condition of heat treatment temperature and heat treatment time)
(d) Conditions of surface treatment on magnetic surface (for example, conditions of at least one treatment of surface dusting treatment and surface polishing treatment)
(a) Addition amount of carbon in coating material adjustment step

As the addition amount of carbon in the coating material adjustment step increases, the amount of carbon on the magnetic surface tends to increase. Therefore, the average electron count rates A₁ and A₂ can be adjusted by adjusting the addition amount of carbon in the coating material adjustment step.
(b) Drying conditions of the magnetic layer forming coating material in the application step (for example, at least one condition selected from the group consisting of a drying temperature and a drying time)

### (Drying Temperature)

As the drying temperature of the magnetic layer forming coating material in the application step increases, the organic component (binder or the like) easily floats in the coating film of the magnetic layer forming coating material, and the amount of the organic component present on the magnetic surface increases. As a result, the holes 43A on the magnetic surface are blocked by the organic component, and the amount of a lubricant on the magnetic surface tends to decrease. Therefore, the average electron count rates A₁ and A₂ can be adjusted by adjusting the drying temperature of the magnetic layer forming coating material in the application step.

### (Drying Time)

As the drying time of the magnetic layer forming coating material in the application step becomes longer, floating of an organic component (binder or the like) in the coating film of the magnetic layer forming coating material is suppressed, and the amount of carbon on the magnetic surface tends to increase. Therefore, the average electron count rates A₁ and A₂ can be adjusted by adjusting the drying time of the magnetic layer forming coating material in the application step.
(c) Conditions of heat treatment in curing step (for example, at least one condition of heat treatment temperature and heat treatment time)

### (Heating Treatment Temperature)

When the heat treatment temperature in the curing step increases, the curing of the magnetic layer 43 proceeds, and the calendering efficiency tends to decrease. When the calendering efficiency decreases, the lubricant tends to easily come out on the magnetic surface. Therefore, the average electron count rates A₁ and A₂ can be adjusted by adjusting the heat treatment temperature in the curing step. In the present specification, the calendering efficiency means the thickness change rate of the magnetic layer 43 before and after the calendering treatment, and the larger the thickness change rate, the higher the calendering efficiency.

### (Heating Treatment Time)

When the heat treatment time in the curing step increases, the curing of the magnetic layer 43 proceeds, and the calendering efficiency tends to decrease. When the calendering efficiency decreases, the lubricant tends to easily come out on the magnetic surface. Therefore, the average electron count rates A₁ and A₂ can be adjusted by adjusting the heat treatment time in the curing step.
(d) Presence or absence of surface treatment on magnetic surface (for example, conditions of at least one treatment of surface dusting treatment and surface polishing treatment)

### (Surface Dusting Treatment)

When the surface dusting treatment is performed, an unnecessary binder present on the magnetic surface can be removed. Therefore, the average electron count rates A₁ and A₂ can be adjusted by adjusting the conditions of the surface dusting treatment. The surface dusting treatment is, for example, a treatment of rubbing the magnetic surface with a dusting tape or the like to remove the binder from the magnetic surface. The dusting tape is configured to be able to remove the binder and the like from the magnetic surface while suppressing damage to the magnetic surface. The dusting tape includes, for example, a nonwoven fabric. The nonwoven fabric may contain synthetic fibers or the like. The surface dusting treatment may be performed, for example, after the calendering step and before the cutting step, or may be performed after the cutting step and before the servo write step.

### (Surface Polishing Treatment)

When the surface polishing treatment is applied to the magnetic surface, the organic component of the magnetic surface is scraped off, and an exposure amount of carbon on the magnetic surface increases. Therefore, the average electron count rates A₁ and A₂ can be adjusted by adjusting the conditions of the surface polishing treatment. The surface polishing treatment may be performed by, for example, a wrapping tape or the like. The surface polishing treatment may be performed, for example, after the calendering step and before the cutting step, or may be performed after the cutting step and before the servo write step.

### [Operations and Effects]

As described above, in the magnetic tape MT according to one embodiment, y(=(A₂/A₀)−(A₁/A₀))/(A₂/A₀) satisfies 0.20≤y≤0.49. As a result, since an appropriate amount of the lubricant and the carbon particles are present on the magnetic surface, it is possible to suppress an increase in dynamic friction between the head and the magnetic surface even after traveling many times.

### [6 Modifications]

In one embodiment described above, a case where the magnetic tape cartridge is the one-reel type cartridge 10 has been described; however, the magnetic tape cartridge may be a two-reel type cartridge.

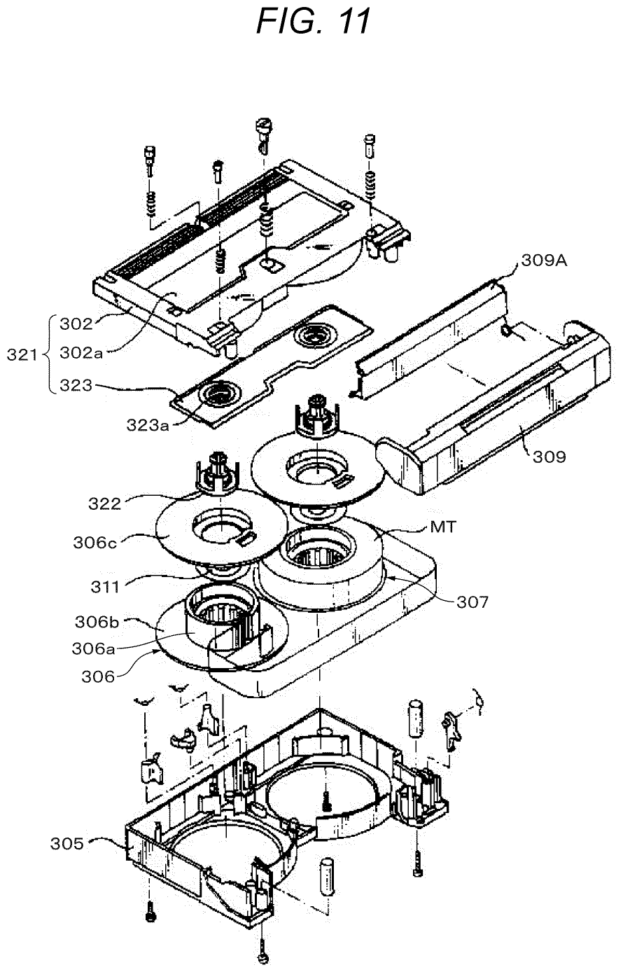

FIG. 11 is an exploded perspective view illustrating an example of a configuration of a two-reel type cartridge 321. The cartridge 321 includes an upper half 302 including a synthetic resin, a transparent window member 323 fitted and fixed to a window portion 302a opened in an upper surface of the upper half 302, a reel holder 322 fixed to an inner side of the upper half 302 and preventing uplift of reels 306 and 307, a lower half 305 corresponding to the upper half 302, the reels 306 and 307 accommodated in a space formed by combining the upper half 302 and the lower half 305, a magnetic tape MT wound around the reels 306 and 307, a front lid 309 closing a front side opening formed by combining the upper half 302 and the lower half 305, and a back lid 309A protecting the magnetic tape MT exposed at the front side opening.

The reels 306 and 307 are for winding the magnetic tape MT. The reel 306 includes a lower flange 306b including, in a central portion, a cylindrical hub portion 306a around which the magnetic tape MT is wound, an upper flange 306c having substantially the same size as the lower flange 306b, and a reel plate 311 interposed between the hub portion 306a and the upper flange 306c. The reel 307 has a configuration similar to that of the reel 306.

The window member 323 is provided with attachment holes 323a at positions corresponding to the reels 306 and 307, respectively, for assembling the reel holder 322 as a reel holding unit that prevents the reels from being lifted up. The magnetic tape MT is similar to the magnetic tape MT in the one embodiment.

### EXAMPLES

Hereinafter, the present disclosure will be specifically described with reference to Examples, but the present disclosure is not limited to these Examples.

In the following Examples and Comparative Examples, an average electron count rate A₀ of the standard sample, an average electron count rate A₁ of the magnetic tape before cleaning, and an average electron count rates A₂ of the magnetic tape after cleaning, x(=A₂−A₁), and y (=((A₂/A₀)−(A₁/A₀))/(A₂/A₀)) are values obtained by the measurement method described in one embodiment described above.

In the following Examples and Comparative Examples, the set light amount at the time of measuring the average electron count rate A₀ of the standard sample was set to 50 nmW. The average electron count rate A₀ of the standard sample at the set light amount was 709 cps (see Table 1).

In the following Examples and Comparative Examples, the set light amount at the time of measuring the average electron count rate A₁ of the sample before cleaning (magnetic tape before cleaning) was set to 500 nmW.

In the following Examples and Comparative Examples, the set light amount at the time of measuring the average electron count rate A₂ of the sample after cleaning (magnetic tape after cleaning) was set to 500 nmW.

Furthermore, in the following Examples and Comparative Examples, an average particle volume of the magnetic particles, an average thickness of the magnetic layer, an average thickness of the underlayer, an average thickness of the PEN film (base), an average thickness of the back layer, an average thickness of the magnetic tape, a square ratio S1 of the magnetic layer in the vertical direction of the magnetic tape, and a square ratio S2 of the magnetic layer in the longitudinal direction of the magnetic tape are also values obtained by the measurement method described in one embodiment described above.

### Example 1

### (Preparation Step of Magnetic Layer Forming Coating Material)

A magnetic layer forming coating material was prepared as follows. First, a first composition having the following formulation was kneaded with an extruder. Next, the kneaded first composition, and a second composition and a third composition having the following formulations were added to a stirring tank provided with a disperser, and premixing was performed. Subsequently, dyno mill mixing was further performed, and filter treatment was performed to prepare a magnetic layer forming coating material.

### (First Composition)

Barium ferrite (BaFe₁₂O₁₉) particles (average particle volume 1600 nm³): 100.0 parts by mass
Vinyl chloride-based resin: 25.0 parts by mass
(Formulation of vinyl chloride-based resin solution: Blending amount of vinyl chloride-based resin 30.0% by mass, blending amount of cyclohexanone solution 70.0% by mass)
(Vinyl chloride-based resin: Degree of polymerization 300, number average molecular weight Mn=10000, containing OSO₃K=0.07 mmol/g, and secondary OH=0.3 mmol/g as a polar group)
Polyurethane resin solution: 30.0 parts by mass
(Formulation of polyurethane resin solution: Blending amount of polyurethane resin 30.0% by mass, blending amount of cyclohexanone 70.0% by mass)
(Polyurethane resin: Number average molecular weight Mn=25000, glass transition temperature Tg=110° C.)
Phenylphosphonic acid: 3.0 parts by mass
n-butyl stearate: 2.0 parts by mass
Methyl ethyl ketone: 121.0 parts by mass
Toluene: 121.0 parts by mass
Cyclohexanone: 116.0 parts by mass

### (Second Composition)

Aluminum oxide powder: 3.0 parts by mass (α-Al₂O₃, average particle diameter: 0.1 μm)
Vinyl chloride-based resin solution: 3.0 parts by mass
(Formulation of vinyl chloride-based resin solution: Blending amount of vinyl chloride-based resin 30.0% by mass, blending amount of cyclohexanone solution 70.0% by mass)
(Vinyl chloride-based resin: Degree of polymerization 300, number average molecular weight Mn=10000, containing OSO₃K=0.07 mmol/g, and secondary OH=0.3 mmol/g as a polar group)

### (Third Composition)

Carbon black: 2.5 parts by mass (manufactured by Tokai Carbon Co., Ltd., trade name: SEAST S, arithmetic average particle size 70 nm)
Vinyl chloride-based resin solution: 2.0 parts by mass
(Formulation of vinyl chloride-based resin solution: Blending amount of vinyl chloride-based resin 30.0% by mass, blending amount of cyclohexanone solution 70.0% by mass)
(Vinyl chloride-based resin: Degree of polymerization 300, number average molecular weight Mn=10000, containing OSO₃K=0.07 mmol/g, and secondary OH=0.3 mmol/g as a polar group)

Finally, 2.0 parts by mass of polyisocyanate (trade name: Coronate L, manufactured by Tosoh Corporation) as a curing agent and 2.0 parts by mass of stearic acid were added to the magnetic layer forming coating material prepared as described above.

### (Preparation Step of Underlayer Forming Coating Material)

An underlayer forming coating material was prepared as follows. First, a fourth composition having the following formulation was kneaded with an extruder. Next, the kneaded fourth composition and a fifth composition having the following formulation were added to a stirring tank provided with a disperser, and premixing was performed. Subsequently, dyno mill mixing was further performed and filter treatment was performed to prepare the underlayer forming coating material.

### (Fourth Composition)

Needle-shaped iron oxide powder: 100.0 parts by mass
(α-Fe₂O₃, average long axis length 0.11 μm) Vinyl chloride-based resin solution: 50.0 parts by mass
(Formulation of vinyl chloride-based resin solution: Blending amount of vinyl chloride-based resin 30.0% by mass, blending amount of cyclohexanone solution 70.0% by mass),
(Vinyl chloride-based resin: Degree of polymerization 300, number average molecular weight Mn=10000, containing OSO₃K=0.07 mmol/g, and secondary OH=0.3 mmol/g as a polar group)
Aluminum oxide powder: 3.0 parts by mass (α-Al₂O₃, average particle diameter: 0.1 μm)

### (Fifth Composition)

Carbon black (manufactured by Asahi Carbon Co., Ltd., trade name: #80): 25.0 parts by mass
Polyurethane resin solution: 50.0 parts by mass
(Formulation of polyurethane resin solution: Blending amount of polyurethane resin 30.0% by mass, blending amount of cyclohexanone 70.0% by mass)
(Polyurethane resin: Number average molecular weight Mn=25000, glass transition temperature Tg=70° C.)
n-butyl stearate: 2.0 parts by mass
Methyl ethyl ketone: 108.2 parts by mass
Toluene: 108.2 parts by mass
Cyclohexanone: 100.0 parts by mass

Finally, 1.5 parts by mass of polyisocyanate (trade name: Coronate L, manufactured by Tosoh Corporation) as a curing agent and 2.0 parts by mass of stearic acid were added to the underlayer forming coating material prepared as described above.

### (Preparation Step of Back Layer Forming Coating Material)

A back layer forming coating material was prepared as follows. The following raw materials were mixed in a stirring tank provided with a disperser and subjected to filter treatment to prepare the back layer forming coating material.
Carbon black (manufactured by Asahi Carbon Co., Ltd., trade name: #80): 100.0 parts by mass
Polyester polyurethane resin solution (manufactured by Nippon Polyurethane Industry Co., Ltd., trade name: N-2304): 150.0 parts by mass
(Formulation of polyester polyurethane resin solution: Blending amount of polyester polyurethane resin 30.0% by mass, blending amount of cyclohexanone 70.0% by mass)
Methyl ethyl ketone: 500.0 parts by mass
Toluene: 400.0 parts by mass
Cyclohexanone: 100.0 parts by mass
Polyisocyanate (manufactured by Tosoh Corporation, trade name: Coronate L): 9.0 parts by mass

### (Application Step)

An underlayer and a magnetic layer were formed in the following manner on one principal surface of an elongated PEN film (base) having an average thickness of 4.00 μm using the magnetic layer forming coating material and the underlayer forming coating material prepared as described above. First, the underlayer forming coating material was applied onto one principal surface of the PEN film to be dried to form an underlayer so that the average thickness was 0.80 μm after the calendering treatment. Next, the magnetic layer forming coating material was applied onto the underlayer to be dried to form a magnetic layer so that the average thickness was 75 nm after the calendering treatment. When the magnetic layer forming coating material is dried, magnetic field orientation of barium ferrite particles in the thickness direction of the PEN film was performed by a solenoid coil. Therefore, the square ratio S1 of the magnetic tape in the vertical direction (thickness direction) was set to 65%, and the square ratio S2 of the magnetic tape in the longitudinal direction was set to 38%.

After the underlayer and the magnetic layer were formed, the back layer forming coating material was applied onto the other principal surface of the PEN film to be dried to form a back layer so that the average thickness was 0.35 μm after the calendering treatment. Therefore, the magnetic tape was obtained.

### (Curing Step)

After the magnetic tape is wound into a roll shape, heat treatment is performed at 60° C. for 50 hours in this state to the magnetic tape to cure the underlayer and the magnetic layer.

### (Calendering Step)

The calendering treatment was performed to the magnetic tape after curing to smooth a surface of the magnetic layer. At this time, the calendering treatment temperature was 100° C., and the calendering treatment pressure was 200 kg/cm.

### (Cutting Step)

The magnetic tape obtained as described above was cut into a width of ½ inch (12.65 mm). Therefore, a magnetic tape having an average thickness of 5.23 μm was obtained.

### (Servo Write Step)

After the magnetic tape after cutting was demagnetized, a servo pattern was written on the magnetic tape using a servo writer to form five servo bands. The servo pattern conforms to the LTO-9 standard. As described above, a target magnetic tape was obtained.

(Adjustment Conditions of Average Electron Count Rates A₁ and A₂)

In Example 1, the average electron count rate A₁ of the magnetic tape before cleaning was set to 301, and the average electron count rate A₂ of the magnetic tape after cleaning was set to 472 by adjusting the addition amount of carbon in the coating material adjustment step, the drying condition of the magnetic layer forming coating material in the application step, and the condition of the heat treatment in the curing step.

### Example 2

In the application step, by making an application speed of the magnetic layer forming coating material faster than an application speed of the magnetic layer forming coating material of Example 1, the drying time of the magnetic layer forming coating material was made shorter than the drying time of the magnetic layer forming coating material of Example 1, and the drying start time was made earlier than the drying start time of the magnetic layer forming coating material of Example 1. Furthermore, in the curing step, the heat treatment temperature of the magnetic layer forming coating material was lowered as compared with Example 1. Therefore, A₁=232 and A₂=391 were set. The magnetic tape was obtained in a manner similar to that in Example 1 except for them.

### Example 3

After the cutting step and before the servo write step, the magnetic surface was subjected to the surface dusting tape treatment with a dusting tape, thereby setting A₁=289 and A₂=397. The magnetic tape was obtained in a manner similar to that in Example 2 except for them.

### Example 4

After the cutting step and before the servo write step, the magnetic surface was subjected to the surface dusting treatment with a dusting tape, thereby setting A₁=313 and A₂=437. The magnetic tape was obtained in a manner similar to that in Example 1 except for them.

### Example 5

After the cutting step and before the servo write step, the magnetic surface was subjected to the polishing treatment with a wrapping tape, thereby setting A₁=309 and A₂=399. The magnetic tape was obtained in a manner similar to that in Example 2 except for them.

### Example 6

A₁=297 and A₂=546 were set by increasing the blending amount of carbon black of the third composition to 3.0% by mass in the preparation step of the magnetic layer forming coating material and shortening the heat treatment time of the magnetic layer forming coating material as compared with Example 1 in the curing step. The magnetic tape was obtained in a manner similar to that in Example 1 except for them.

### Comparative Example 1

In the preparation step of the magnetic layer forming coating material, the blending amount of carbon black of the third composition was increased to 3.0% by mass. Furthermore, by making an application speed of the magnetic layer forming coating material higher than an application speed of the magnetic layer forming coating material of Example 1, the drying time of the magnetic layer forming coating material was made shorter than the drying time of the magnetic layer forming coating material of Example 1, and the drying start time was made earlier than the drying start time of the magnetic layer forming coating material of Example 1. Therefore, A₁=224 and A₂=486 were set. The magnetic tape was obtained in a manner similar to that in Example 1 except for them.

### Comparative Example 2

In the preparation step of the magnetic layer forming coating material, the blending amount of carbon black of the third composition was increased to 3.0% by mass, and a drying temperature of the magnetic layer forming coating material was made higher than a drying temperature of the magnetic layer forming coating material in Example 1, thereby setting A₁=254 and A₂=513. The magnetic tape was obtained in a manner similar to that in Example 1 except for them.

### Comparative Example 3

In the preparation step of the magnetic layer forming coating material, A₁=527 and A₂=605 were set by increasing the blending amount of carbon black of the third composition to 3.5% by mass. The magnetic tape was obtained in a manner similar to that in Example 1 except for them.

### Comparative Example 4

In the preparation step of the magnetic layer forming coating material, the addition amount of carbon of the third composition was changed to 3.0 parts by mass. In the application step, the application conditions of the underlayer forming coating material were adjusted so that the average thickness of the underlayer after the calendering treatment was 0.6 μm. In the application step, an application speed of the magnetic layer forming coating material was made faster than an application speed of the magnetic layer forming coating material of Example 1. Therefore, A₁=1394 and A₂=1690 were set. The magnetic tape was obtained in a manner similar to that in Example 1 except for them.

### [Evaluation]

The following evaluations were performed on the magnetic tapes obtained as described above.

### (Arithmetic Average Roughness Ra)

The arithmetic average roughness Ra of the magnetic surface was obtained by the method described in one embodiment described above.

(Adhesion of Configuration Material of Magnetic Layer to Head after 25 Times Full Length Full Surface Traveling)

First, the LTO cartridge was loaded into an LTO drive connected to a personal computer (hereinafter referred to as “PC”) via a small computer system interface (SCSI). Then, a so-called full volume test of recording and reproducing data on the entire surface of the magnetic tape by operating the LTO drive by the PC was performed 25 times.

Thereafter, the head of the drive was observed with an optical microscope to confirm whether or not the configuration material of the magnetic layer is adhered to the head. Next, the adhesion of the configuration material of the magnetic layer to the head after 25 times full length full surface traveling was evaluated in accordance with the following five-level criteria.
5: No adhesion of the configuration material of the magnetic layer to the head is observed.
4: No adhesion of the configuration material of the magnetic layer is observed on a tape traveling surface of the head, and adhesion of the configuration material of the magnetic layer is observed at a corner portion of the head in contact with the tape.
3: In the tape traveling surface of the head, adhesion of the configuration material of the magnetic layer is observed only in an edge part where a tape edge travels.
2: Adhesion of the configuration material of the magnetic layer is observed in any part of the tape traveling surface of the head.
1: A fail state occurs due to adhesion of the configuration material of the magnetic layer.

If the evaluation result is “3”, “4”, or “5”, a reliability problem of the magnetic tape is unlikely to occur.

If the evaluation result is “2”, short-term head clogging is likely to occur, and the total capacity of the cartridge may become insufficient.

The “fail state” in the evaluation result “1” refers to a state in which the traveling state of the magnetic tape becomes unstable and the drive automatically completely stops recording.

### (Dynamic Friction Coefficient Ratio μ(250)/μ(5))

The dynamic friction coefficient ratio (μ(250)/μ(5)) of the magnetic tape was obtained by the method described in one embodiment described above.

### (SNR)

First, a reproduction signal of the magnetic tape was acquired using a loop tester (manufactured by Microphysics Inc.). The acquisition conditions of the reproduction signal will be described below.
Head: Write read head in the LTO9 specification
Headspeed: 1.85 m/s
Signal: Single recording frequency 10 MHz (as a 2T half-Nyquist frequency)
Recording current: Optimum recording current

In consideration of signal processing, measurement was performed at 2T (92.5 nm) assuming a bit length of 46.25 nm.

Next, the reproduction signal was captured at a span (SPAN) of 0 to 20 MHz (resolution band width=100 kHz, VBW=30 kHz) with a spectrum analyzer. Next, a peak of the captured spectrum was regarded as a signal amount S, and the floor noise obtained by excluding the peak was integrated from 3 MHz to 20 MHz to obtain a noise amount N. A ratio S/N of the signal amount S to the noise amount N was obtained as a signal-to-noise ratio (SNR). Next, the obtained SNR was converted into a relative value (dB) based on the SNR in Comparative Example 4 as a reference medium.

The evaluation results of the magnetic tapes of Examples 1 to 5 and Comparative Examples 1 to 5 are shown in Table 1. FIG. 12 illustrates a relationship between A₂−A₁ and ((A₂/A₀)−(A₁/A₀))/(A₂/A₀) in the magnetic tapes of Examples 1 to 5 and Comparative Examples 1 to 5. Note that, in FIG. 12, A₂−A₁ is an x-axis coordinate, and ((A₂/A₀)−(A₁/A₀))/(A₂/A₀) is a y-axis coordinate.

TABLE 1

| | | | Average | | | | | |
|---|---|---|---|---|---|---|---|---|
| | | | electron | | | | | |
| | Average | | count | | | | | |
| | electron | | rate of | | | | | |
| | count rate | | standard | | | | | |
| | (set light | | sample | Normalized | | | | |
| | amount: | | (Au) (set | average | | | | |
| | 500 nW) | | light | electron | | | | Magnetic |
| | [cps] | | amount: | count rate | | | y (=((A₂/ | tape |
| | A₁ | A₂ | 50 nW) | A₁/A₀ | A₂/A₀ | x (=A₂ − | A₀) − | average |
| | (before | (after | [cps] | (before | (after | A₁) | (A₁/A₀))/ | thickness |
| | cleaning) | cleaning) | A₀ | cleaning) | cleaning) | [cps] | (A₂/A₀)) | [μm] |
| Example | 301 | 472 | 709 | 0.42 | 0.67 | 171 | 0.36 | 5.23 |
| 1 | | | | | | | | |
| Example | 232 | 391 | 709 | 0.33 | 0.55 | 159 | 0.41 | 5.23 |
| 2 | | | | | | | | |
| Example | 289 | 397 | 709 | 0.41 | 0.56 | 108 | 0.27 | 5.23 |
| 3 | | | | | | | | |
| Example | 313 | 437 | 709 | 0.44 | 0.62 | 124 | 0.28 | 5.33 |
| 4 | | | | | | | | |
| Example | 309 | 399 | 709 | 0.44 | 0.56 | 90 | 0.23 | 5.33 |
| 5 | | | | | | | | |
| Example | 297 | 546 | 709 | 0.42 | 0.77 | 249 | 0.46 | 5.23 |
| 6 | | | | | | | | |
| Comparative | 224 | 486 | 709 | 0.32 | 0.69 | 262 | 0.54 | 5.23 |
| Example | | | | | | | | |
| 1 | | | | | | | | |
| Comparative | 254 | 513 | 709 | 0.36 | 0.72 | 259 | 0.50 | 5.22 |
| Example | | | | | | | | |
| 2 | | | | | | | | |
| Comparative | 527 | 605 | 709 | 0.74 | 0.85 | 78 | 0.13 | 5.31 |
| Example | | | | | | | | |
| 3 | | | | | | | | |
| Comparative | 1394 | 1690 | 709 | 1.97 | 2.38 | 296 | 0.18 | 5.21 |
| Example | | | | | | | | |
| 4 | | | | | | | | |

| | | | | | Adhesion | | |
|---|---|---|---|---|---|---|---|
| | | | | | of head | Dynamic | |
| | Magnetic | | | Arithmetic | after 25 | friction | |
| | layer | Underlayer | Base | average | times full | coefficient | |
| | average | average | average | roughness | length full | ratio | |
| | thickness | thickness | thickness | Ra | surface | μ(250)/ | SNR |
| | [μm] | [μm] | [μm] | [nm] | traveling | μ(5) | [dB] |
| Example | 75 | 0.8 | 4.0 | 1.9 | 4 | 1.05 | 0.1 |
| 1 | | | | | | | |
| Example | 75 | 0.8 | 4.0 | 1.5 | 5 | 1.02 | 0.9 |
| 2 | | | | | | | |
| Example | 75 | 0.8 | 4.0 | 1.6 | 3 | 1.17 | 0.7 |
| 3 | | | | | | | |
| Example | 80 | 0.9 | 4.0 | 1.7 | 4 | 1.12 | 0.4 |
| 4 | | | | | | | |
| Example | 80 | 0.9 | 4.0 | 1.7 | 3 | 1.25 | 0.6 |
| 5 | | | | | | | |
| Example | 75 | 0.8 | 4.0 | 1.7 | 5 | 1.04 | −1.2 |
| 6 | | | | | | | |
| Comparative | 75 | 0.8 | 4.0 | 1.6 | 5 | 4.15 | −0.1 |
| Example | | | | | | | |
| 1 | | | | | | | |
| Comparative | 70 | 0.8 | 4.0 | 1.9 | 3 | 3.70 | −2.6 |
| Example | | | | | | | |
| 2 | | | | | | | |
| Comparative | 60 | 0.7 | 4.2 | 1.7 | 1 | 5.52 | −1.9 |
| Example | | | | | | | |
| 3 | | | | | | | |
| Comparative | 60 | 0.6 | 4.2 | 2.0 | 2 | 3.21 | 0.0 |
| Example | | | | | | | |
| 4 | | | | | | | |

Standard sample (Au): Manufactured by Riken Keiki Co., Ltd., model 9161 4361 20
A₀: Average electron count rate of standard sample
A₁: Average electron count rate of magnetic tape before cleaning (before removing lubricant)
A₂: Average electron count rate of magnetic tape after cleaning (after removing lubricant)

Here, the “cleaning” refers to a process of immersing a sample in hexane for 24 hours to remove the lubricant, and then naturally drying the sample.

The following are understood from the above-described evaluation result.

When y falls within a range of 0.20≤y≤0.49, an increase in the dynamic friction coefficient ratio (μ(250)/μ(5)) of the magnetic tape can be suppressed. Furthermore, it is possible to suppress adhesion of the configuration material of the magnetic layer to the head.

When y falls within the range of 0.20≤y≤0.49 and x falls within a range of 80 cps≤x≤230 cps, in addition to the above effect, an effect of improving electromagnetic conversion characteristics is obtained.

The embodiment and modifications of the present disclosure have been specifically described above, but the present disclosure is not limited to the above-described embodiment and modifications, and various modifications based on the technical idea of the present disclosure can be made. For example, configurations, methods, steps, shapes, materials, numerical values, and the like in the above-described embodiment and modifications are merely examples, and different configurations, methods, steps, shapes, materials, numerical values, and the like may be employed as necessary. The configurations, methods, steps, shapes, materials, numerical values, and the like of the above-described embodiment and modifications can be combined with each other without departing from the gist of the present disclosure.

The chemical formulas of the compounds and the like exemplified in the above-described embodiment and modifications are representative, and are not limited to the described valences and the like as long as they are common names of the same compounds. In numerical value ranges described in stages in the embodiment and modifications described above, an upper limit value or a lower limit value of a numerical value range of a certain stage may be replaced with an upper limit value or a lower limit value of the numerical value range of another stage. The materials exemplified in the embodiment and modifications described above may be used alone or in combination of two or more unless otherwise specified.

Furthermore, the present disclosure may also employ the following configurations.

(1)

A magnetic recording medium in a tape shape, including:
a base; and
a magnetic layer, in which
the magnetic recording medium contains a lubricant,
the magnetic layer contains magnetic particles, a binder, and carbon, and
in a case where an average electron count rate of a surface of a standard sample measured by atmospheric photoelectron yield spectroscopy is A₀, an average electron count rate of a surface of the magnetic layer measured by the atmospheric photoelectron yield spectroscopy before cleaning of the magnetic recording medium is A₁, and an average electron count rate of the surface of the magnetic layer measured by the atmospheric photoelectron yield spectroscopy after cleaning of the magnetic recording medium is A₂, ((A₂/A₀)−(A₁/A₀))/(A₂/A₀) satisfies 0.20≤((A₂/A₀)−(A₁/A₀))/(A₂/A₀)≤0.49.
   (2)

The magnetic recording medium according to (1), in which

$$( ( {A}_{2} / {A}_{0} ) - ( {A}_{1} / {A}_{0} ) ) / ( {A}_{2} / {A}_{0} ) satisfies \\ 0.23 \leq ( ( {A}_{2} / {A}_{0} ) - ( {A}_{1} / {A}_{0} ) ) / ( {A}_{2} / {A}_{0} ) \leq 0.41 .$$

(3)

The magnetic recording medium according to (1) or (2), in which
A₂−A₁ satisfies 80 cps≤A₂−A₁≤230 cps.
   (4)

The magnetic recording medium according to any one of (1) to (3), in which
A₂−A₁ satisfies 90 cps≤A₂−A₁≤171 cps.
   (5)

The magnetic recording medium according to any one of (1) to (4), in which
an arithmetic average roughness Ra of the surface of the magnetic layer is 2.0 nm or less.
   (6)

The magnetic recording medium according to any one of (1) to (5), in which
with respect to a dynamic friction coefficient μ between the surface of the magnetic layer and a magnetic head when a tension applied to the magnetic recording medium is 0.6 N, a dynamic friction coefficient ratio (μ(250)/μ(5)) between a dynamic friction coefficient μ(5) in fifth travel and a dynamic friction coefficient μ(250) in 250th travel is 1.00 or more and 1.25 or less.
   (7)

The magnetic recording medium according to any one of (1) to (6), in which
an average thickness of the magnetic layer is 60 nm or less.
   (8)

The magnetic recording medium according to any one of (1) to (7), further including
an underlayer, in which
an average thickness of the underlayer is 0.90 μm or less.
   (9)

The magnetic recording medium according to any one of (1) to (8), in which
an average thickness of the magnetic recording medium is 5.30 μm or less.
   (10)

The magnetic recording medium according to any one of (1) to (9), in which
an average particle volume of the magnetic particles is 1600 nm³ or less.
   (11)

The magnetic recording medium according to any one of (1) to (10), in which
the magnetic particles contain hexagonal ferrite, ε-iron oxide, or Co-containing spinel ferrite.
   (12)

The magnetic recording medium according to any one of (1) to (11), in which
the magnetic layer includes a servo pattern,
the servo pattern includes a plurality of first magnetization regions and a plurality of second magnetization regions, and
the plurality of first magnetization regions and the plurality of second magnetization regions are asymmetric with respect to an axis parallel to a width direction of the magnetic recording medium.
   (13)

The magnetic recording medium according to (12), in which
an inclination angle of the first magnetization region with respect to the axis is different from an inclination angle of the second magnetization region with respect to the axis, and
a larger one of the inclination angle of the first magnetization region and the inclination angle of the second magnetization region is 180 or more and 28° or less.
   (14)

A cartridge including the magnetic recording medium according to any one of (1) to (13).

### REFERENCE SIGNS LIST

10, 321 Cartridge
11 Cartridge memory
31 Antenna coil
32 Rectification/power supply circuit
33 Clock circuit
34 Detection/modulation circuit
35 Controller
36 Memory
36A First storage region
36B Second storage region
41 Base
42 Underlayer
42A Hole
43 Magnetic layer
43A Hole
44 Back layer
45 Lubricant layer
56 Head unit
56A, 56B Servo read head
110 Servo frame
111 Servo subframe 1
112 Servo subframe 2
113 Servo stripe
111A A burst
111B B burst
112C C burst
112D D burst
MT Magnetic tape
SB Servo band
DB Data band
Tk Data track

1. A magnetic recording medium in a tape shape, comprising:
a base; and
a magnetic layer, wherein
the magnetic recording medium contains a lubricant,
the magnetic layer contains magnetic particles, a binder, and carbon, and
in a case where an average electron count rate of a surface of a standard sample measured by atmospheric photoelectron yield spectroscopy is A₀, an average electron count rate of a surface of the magnetic layer measured by the atmospheric photoelectron yield spectroscopy before cleaning of the magnetic recording medium is A₁, and an average electron count rate of the surface of the magnetic layer measured by the atmospheric photoelectron yield spectroscopy after cleaning of the magnetic recording medium is A₂, ((A₂/A₀)−(A₁/A₀))/(A₂/A₀) satisfies 0.20≤((A₂/A₀)−(A₁/A₀))/(A₂/A₀)≤0.49.

2. The magnetic recording medium according to claim 1, wherein
((A₂/A₀)−(A₁/A₀))/(A₂/A₀) satisfies 0.23≤((A₂/A₀)−(A₁/A₀))/(A₂/A₀)≤0.41.

3. The magnetic recording medium according to claim 1, wherein
A₂−A₁ satisfies 80 cps≤A₂−A₁≤230 cps.

4. The magnetic recording medium according to claim 1, wherein
A₂−A₁ satisfies 90 cps≤A₂−A₁≤171 cps.

5. The magnetic recording medium according to claim 1, wherein
an arithmetic average roughness Ra of the surface of the magnetic layer is 2.0 nm or less.

6. The magnetic recording medium according to claim 1, wherein
with respect to a dynamic friction coefficient μ between the surface of the magnetic layer and a magnetic head when a tension applied to the magnetic recording medium is 0.6 N, a dynamic friction coefficient ratio (μ(250)/μ(5)) between a dynamic friction coefficient μ(5) in fifth travel and a dynamic friction coefficient μ(250) in 250th travel is 1.00 or more and 1.25 or less.

7. The magnetic recording medium according to claim 1, wherein
an average thickness of the magnetic layer is 60 nm or less.

8. The magnetic recording medium according to claim 1, further comprising
an underlayer, wherein
an average thickness of the underlayer is 0.90 μm or less.

9. The magnetic recording medium according to claim 1, wherein
an average thickness of the magnetic recording medium is 5.30 μm or less.

10. The magnetic recording medium according to claim 1, wherein
an average particle volume of the magnetic particles is 1600 nm³ or less.

11. The magnetic recording medium according to claim 1, wherein
the magnetic particles contain hexagonal ferrite, ε-iron oxide, or Co-containing spinel ferrite.

12. The magnetic recording medium according to claim 1, wherein
the magnetic layer includes a servo pattern,
the servo pattern includes a plurality of first magnetization regions and a plurality of second magnetization regions, and
the plurality of first magnetization regions and the plurality of second magnetization regions are asymmetric with respect to an axis parallel to a width direction of the magnetic recording medium.

13. The magnetic recording medium according to claim 12, wherein
an inclination angle of the first magnetization region with respect to the axis is different from an inclination angle of the second magnetization region with respect to the axis, and
a larger one of the inclination angle of the first magnetization region and the inclination angle of the second magnetization region is 180 or more and 28° or less.

14. A cartridge comprising the magnetic recording medium according to claim 1.
